(19) United States
(12) Patent Application Publication
(10) Pub. No.: US 2025/0159655 A1
(43) Pub. Date: May 15, 2025

(54) METHOD AND APPARATUS OF PAGING FOR USER EQUIPMENT RECEIVING WAKE-UP SIGNAL IN WIRELESS COMMUNICATION SYSTEM

(71) Applicant: Samsung Electronics Co., Ltd., Gyeonggi-do (KR)

(72) Inventors: Seunghoon CHOI, Gyeonggi-do (KR); Hyunsuk RYU, Gyeonggi-do (KR); Hyewon YANG, Gyeonggi-do (KR); Jaewon LEE, Gyeonggi-do (KR)

(21) Appl. No.: 18/946,445

(22) Filed: Nov. 13, 2024

(30) Foreign Application Priority Data
Nov. 14, 2023 (KR) 10-2023-0157202

(51) Int. Cl. H04W 68/02; H04W 52/02

(52) U.S. Cl. CPC H04W 68/02; H04W 52/0235

(57) ABSTRACT

The disclosure relates to a fifth generation (5G) or sixth generation (6G) communication system for supporting a higher data transmission rate. A method performed by a user equipment (UE) in a communication system includes receiving, via higher layer signaling, a configuration of a first number of paging occasions (POs) for a paging frame (PF), the first number of POs being associated with the UE with capability of reception of a wake-up signal (WUS), receiving the WUS, identifying, based on the configuration, the first number of POs, and monitoring the first number of POs to receive downlink control information (DCI) for a paging message.

### CROSS REFERENCE TO RELATED APPLICATION

The present application claims priority to Korean Patent Application No. 10-2023-0157202, filed in the Korean Intellectual Property Office on Nov. 14, 2023, the entire content of which is incorporated herein by reference.

### BACKGROUND

### 1. Field

The disclosure relates generally to a wireless communication system, and more particularly, to a method and apparatus for paging a user equipment (UE) in a wireless communication system.

### 2. Description of Related Art

Fifth generation (5G) mobile communication technologies define broad frequency bands such that high transmission rates and new services are possible and can be implemented not only in sub 6 gigahertz (GHz) bands such as 3.5 GHz, but also in above 6 GHz bands referred to as millimeter wave (mmWave) bands including 28 GHz and 39 GHz bands. In addition, it has been considered to implement sixth generation (6G) mobile communication technologies referred to as beyond 5G systems in terahertz (THz) bands (e.g., 95 GHz to 3 THz bands) to realize transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

There are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for simplifying random access procedures for NR. There also has been ongoing standardization in system architecture/service regarding a 5G baseline service based architecture or service based interface for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

To process the recent explosive increase in mobile data traffic, the initial standards for 5G NR access technology, the next-generation communication system following the long-term evolution (LTE) (or evolved universal terrestrial radio access (E-UTRA)) and LTE-advanced (LTE-A or E-UTRA Evolution), have been completed. While the conventional mobile communication system generally focuses on voice/data communication, the 5G system aims to meet various services and requirements such as eMBB service, URLLC service, and MTC service supporting massive machine-to-machine communication.

While a system transmission bandwidth for a single carrier in the existing LTE and LTE-A is limited to a maximum of 20 megahertz (MHz), the 5G system mainly aims to support an ultra-high-speed data service reaching several gigabits per second (Gbps) using an ultra-wide bandwidth which is significantly wider than the LTE and LTE-A. Accordingly, the 5G system considers, as a candidate frequency, an ultra-high-frequency band from several GHz in which guaranteeing an ultra-wide bandwidth frequency is relatively easy to a maximum of 100 GHz. In addition, securing a wide bandwidth frequency for the 5G system by rearranging or allocating frequencies among the frequency bands included in hundreds of MHz to several GHz used by the conventional mobile communication system is under consideration.

The radio wave of the ultra-high-frequency band is referred to as mmWave and has a wavelength of several mm. However, since a propagation path loss increases in proportion to frequency band in an ultra-high-frequency band, coverage of the mobile communication system decreases.

To remove the disadvantage of the decreased coverage of the ultra-high-frequency band, a beamforming technology for increasing an arrival distance of the radio wave by concentrating the radiation energy of the radio wave on a predetermined target point through a plurality of antennas is applied. That is, signals to which the beamforming technology is applied have a relatively narrower beam width, and the arrival distance of the radio wave increases since radiation energy is concentrated within the narrowed beam width. The beamforming technology may be applied to each of a transmission end and a reception end. The beamforming technology has not only a coverage increase effect but also an effect of reducing interference in areas out of the beamforming direction. To operate the beamforming technology properly, an accurate measurement and feeding back of transmitted/received beams is needed. The beamforming technology may be applied to a control channel or data channel arranged between a predetermined UE and a predetermined base station (BS) in one-to-one correspondence. To increase coverage, the beamforming technology may be applied to a common signal that the BS transmits to a plurality of UEs within the system, for example, a synchronization signal, a physical broadcast channel (PBCH), and a control channel and data channel for transmitting system information. In a case that the beamforming technology is applied to the common signal, a beam sweeping technology for changing a beam direction and transmitting a signal may be additionally applied, and thus the common signal may reach UEs positioned at a predetermined location within the cell.

Another requirement of the 5G system is an ultra-low latency service having a transmission delay between transmission and reception ends of about 1 ms. To reduce the transmission delay, it is required to design a frame structure based on a shorter transmission time interval (TTI) compared to LTE and LTE-A. The TTI is a basic time unit for scheduling, and the TTI in the conventional LTE and LTE-A systems is 1 ms, corresponding to one subframe length. For example, the short TTI to meet requirements of the ultra-low latency service of the 5G system may include TTIs of 0.5 ms, 0.25 ms, and 0.125 ms, etc., shorter than that of the conventional LTE and LTE-A systems.

To achieve ultra-high-speed data service of up to several Gbps, the 5G system may support to transmit and receive signals in an ultra-wide bandwidth of several tens to several hundreds of MHz or several GHz. Ultra-wide bandwidth signal transmission and reception may be supported through a single component carrier (CC), or through carrier aggregation (CA) technology that combines multiple CCs. When a mobile communication service provider cannot secure a frequency with sufficient bandwidth for providing ultra-high-speed data services with a single CC, in the CA technology, the total frequency bandwidth may be increased by combining CCs with relatively small bandwidth sizes, thereby enabling ultra-high-speed data services.

5G systems are designed and developed for a variety of use cases. In addition to standby time, reliability, and availability, energy efficiency of the UE is very important in 5G systems. In 5G systems, the UE charges on a weekly or daily basis depending on the user's usage time, typically consuming tens of mW in RRC_IDLE/RRC_INACTIVE states and hundreds of mW in RRC_CONNECTED states. Designing for extended battery life may be essential for improving energy efficiency as well as improving user experience. Energy efficiency may be even more important for the UE that does not have a continuous energy source (e.g., UEs using small rechargeable and single coin cell batteries). Among 5G use cases, sensors and actuators are widely deployed for monitoring, measuring, charging, etc., and batteries are typically non-rechargeable and may require a battery life of at least several years. Wearables may also include smartwatches, rings, eHealth-related devices, medical monitoring devices, etc., which are generally difficult to last up to 1 to 2 weeks depending on the usage time.

The power consumption of 5G UEs depends on the configured length of wake-up periods (e.g., paging cycle), and a large extended discontinuous reception (eDRX) cycle may be used to meet the battery life requirement. However, the eDRX scheme is not suitable for low latency services because it maintains a long battery life based on high latency. For example, in a fire detection and extinguishing use case, the fire shutter may need to be closed and the sprinkler may need to be turned on by an actuator within 1 to 2 seconds from the time a fire is detected by a sensor. In this case, latency may be critical, and a long eDRX cycle as before is not suitable because it cannot meet the latency requirement.

As described above, as wireless communication systems develop, a method for transmitting and receiving signals between a UE and a BS including a wake-up receiver (WUR) is required to solve the problem of excessive UE power consumption and achieve high energy efficiency.

Specifically, to solve the problem of excessive power consumption of the UE in a wireless communication system and to achieve high energy efficiency, there is a need in the art for an efficient method and apparatus for determining a paging reception resource of the UE including a WUR.

### SUMMARY OF THE INVENTION

The disclosure has been made to address at least the above-mentioned problems and/or disadvantages and to provide at least the advantages described below.

Accordingly, an aspect of the disclosure is to provide an apparatus and method capable of effectively providing a service in a mobile communication system.

An aspect of the disclosure is to provide a method and apparatus for determining a paging reception resource of a UE including a WUR in a mobile communication system.

In accordance with an aspect of the disclosure, a method performed by a UE in a communication system includes receiving, via higher layer signaling, a configuration of a first number of paging occasions (POs) for a paging frame (PF), the first number of POs being associated with the UE with capability of reception of a wake-up signal (WUS), receiving the WUS, identifying, based on the configuration, the first number of POs, and monitoring the first number of POs to receive downlink control information (DCI) for a paging message.

In accordance with an aspect of the disclosure, a UE in a communication system includes a transceiver, and a processor coupled with the transceiver and configured to: receive, via higher layer signaling, a configuration of a first number of POs for a PF, the first number of POs being associated with the UE with capability of reception of a wake-up signal (WUS), receive the WUS, identify, based on the configuration, the first number of POs, and monitor the first number of POs to receive DCI for a paging message.

In accordance with an aspect of the disclosure, a method performed by a BS in a communication system includes transmitting, to a UE via higher layer signaling, a configuration of a first number of POs for a PF, the first number of POs being associated with the UE with capability of reception of a wake-up signal (WUS), transmitting, to the UE, the WUS, and transmitting, to the UE, DCI for a paging message on at least one of the first number of POs.

In accordance with an aspect of the disclosure, a BS in a communication system includes a transceiver, and a processor coupled with the transceiver and configured to: transmit, to a UE via higher layer signaling, a configuration of a first number of POs for a PF, the first number of POs being associated with the UE with capability of reception of a wake-up signal (WUS), transmit, to the UE, the WUS, and transmit, to the UE, DCI for a paging message on at least one of the first number of POs.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a basic structure of a time-frequency resource domain in a wireless communication system according to an embodiment;

FIG. 2 illustrates a time domain mapping structure of a synchronization signal and beam sweeping according to an embodiment;

FIG. 3 illustrates a signal flow for random access (RA) according to an embodiment;

FIG. 4 illustrates a signal flow for reporting UE capability information by a UE to a BS according to an embodiment;

FIG. 5 illustrates state transitions between a BS and a UE and a state of a UE according to a BS state according to an embodiment;

FIG. 6 illustrate a paging reception scheme of a UE including a WUR according to an embodiment.

FIG. 7 illustrates a paging reception scheme of a UE including a WUR according to an embodiment.

FIG. 8 illustrates a paging reception scheme of a UE including a WUR according to an embodiment;

FIG. 9 illustrate a method for a paging reception of a UE including a WUR according to an embodiment;

FIG. 10 illustrates a method of a BS for transmitting paging according to an embodiment;

FIG. 11 illustrates a structure of a UE according to an embodiment; and

FIG. 12 illustrates a structure of a BS according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Throughout the specification, the same reference numeral refers to the same element.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose and inform those skilled in the art of the scope of the disclosure.

The components in this disclosure are expressed in a singular or plural form. However, the singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

Herein, a BS is an entity that allocates resources to UEs, and may be at least one of a gNode B, a gNB, an eNode B, a Node B, a wireless access unit, a BS controller, and a node on a network. A terminal may include a UE, a mobile station (MS), a cellular phone, a smartphone, a computer, or a multimedia system capable of performing communication functions. Hereinafter, the disclosure will be described with respect to the 5G system as an example, but the embodiments of the disclosure may be equally applied to other communication systems with similar technical backgrounds or channel types, such as LTE or LTE-A mobile communication and future mobile communication technologies beyond 5G. Accordingly, the disclosure will also be applied to other communication systems through some modifications to an extent that does not significantly deviate from the scope of the disclosure when judged by those of skill in the art. For example, the contents of the disclosure may be applied to frequency division duplex (FDD), time division duplex (TDD), cross division duplex (XDD) systems, and subband full duplex (SBFD) systems.

In the disclosure, each of such phrases as A/B, A or B, at least one of A and B, at least one of A or B, A, B, or C, at least one of A, B, and C, and at least one of A, B, or C, may include all possible combinations of the items enumerated together in a corresponding one of the phrases. Such terms as 1st and 2nd, or first and second may be used to simply distinguish a corresponding component from another and does not limit the components in importance or order.

Herein, terms for identifying access nodes and referring to network entities, messages, interfaces between network entities, various identification information, and the like are illustratively used for the sake of convenience. Therefore, the disclosure is not limited by the terms as used below, and other terms with reference to subjects having equivalent technical meanings may be used.

Herein, a physical channel and signal may be interchangeably used with data or a control signal. For example, a physical downlink shared channel (PDSCH) indicates a physical channel through which data is transmitted but may be used to indicate data. That is, expression of ‘transmitting a physical channel’ herein may indicate ‘transmitting data or a signal through a physical channel’.

Higher signaling herein refers to a signal transmission method for transmitting, by a BS, signals to a UE by using a downlink (DL) data channel of a physical layer, or for transmitting, by a UE, signals to a BS by using an uplink (UL) data channel of a physical layer. The higher signaling may be understood as radio resource control (RRC) signaling or a media access control (MAC) control element (CE).

While the disclosure describes various embodiments using terms used in some communication standards (e.g., 3^{rd} generation partnership project (3GPP)), this is for illustrative purposes only. Various embodiments of the disclosure may be easily modified and applied to other communication systems.

Herein, UL may refer to a radio link through which a UE transmits data or a control signal to a BS, and DL may refer to a radio link through which the BS transmits data or a control signal to the UE.

Herein, the operation of a main radio may also be understood as the operation of a UE including the main radio and/or the operation of a processor included in the UE including the main radio.

The operation of a WUR may also be understood as the operation of the UE including the WUR and/or the operation of the processor included in the UE including the WUR.

Unless stated otherwise, the main radio and/or WUR may be used for signal/channel transmission and reception of the UE.

As referred to herein, being on may include both switching from an off state to an on state and maintaining an on state in the on state.

Being off may include both switching from an on state to an off state and maintaining an off state in the off state.

Less than (or less than a specific value, etc.) may be replaced with less than or equal to, and less than or equal to may be replaced with less than.

Exceeding (or greater than a specific value, etc.) may be replaced with greater than or equal to, and greater than or equal to may be replaced with exceeding.

Furthermore, a/b may indicate at least one of a and b.

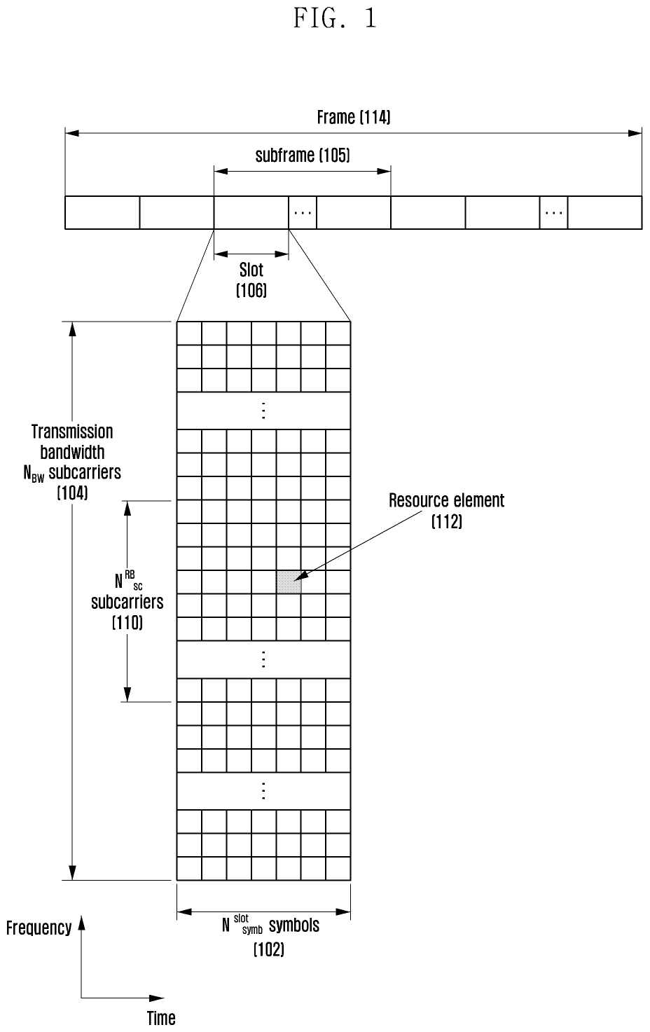

FIG. 1 illustrates a basic structure of a time-frequency resource domain in a wireless communication system according to an embodiment.

Referring to FIG. 1, the time-frequency resource domain is a radio resource domain in which data or a control channel of a 5G system is transmitted.

In FIG. 1, the horizontal axis indicates a time domain and the vertical axis indicates a frequency domain. A minimum transmission unit in the time domain of the wireless communication systems is an orthogonal frequency division multiplexing (OFDM) symbol, and a number of N_{symb}^{slot} symbols 102 may be grouped to form one slot 106, and a number of Nₛₗₒₜ^{subframe} slots may be grouped to form one subframe 105. One subframe has a length of 1.0 ms, and 10 subframes are grouped to form a frame 114 of 10 ms. The minimum transmission unit in the frequency domain is a subcarrier, and the bandwidth of the entire system transmission may be composed of a total number of N_{BW} subcarriers 104.

The basic unit of resources in the time-frequency domain is a resource element (RE) 112, and may be indicated by an OFDM symbol index and a subcarrier index. A resource block (RB) (or physical resource block (PRB)) may be defined by N_{sc}^{RB} contiguous subcarriers 110 in the frequency domain. In the 5G system, N_{sc}^{RB}=12, and the data rate may increase in proportion to the number of RBs scheduled to the UE.

In the wireless communication system, a BS may map data in units of an RB and generally perform scheduling for a certain UE in units of an RB constituting one slot. In other words, in the 5G system, a basic time unit for scheduling may be a slot, and a basic frequency unit for scheduling may be an RB.

The number N_{symb}^{slot} of OFDM symbols is determined based on a length of a cyclic prefix (CP) added to each symbol to prevent inter-symbol interference, and for example, it may be N_{symb}^{slot}=14 when a normal CP is applied, and it may be N_{symb}^{slot}=12 when an extended CP is applied. The extended CP may be applied to a system having a relatively long radio wave transmission distance compared to that for the normal CP, thereby maintaining orthogonality between symbols. For the normal CP, a ratio of a CP length to a symbol length may be maintained at a constant value to keep an overhead due to the CP constant regardless of a subcarrier spacing. In other words, as a subcarrier spacing decreases, a symbol length may increase, and accordingly, a CP length may increase. As a subcarrier spacing increases, a symbol length may decrease, and accordingly, a CP length may decrease. A symbol length and CP length may be inversely proportional to a subcarrier spacing.

In the wireless communication system, to satisfy various services and requirements, various frame structures may be supported by adjusting a subcarrier spacing. For example, in terms of an operating frequency band, a wider subcarrier spacing is more beneficial for recovery from phase noise in a high frequency band. In terms of a transmission time, when a subcarrier spacing increases, a symbol length in the time domain decreases, which leads to a shorter slot, and thus, it is more advantageous for supporting ultra-low latency services such as URLLC. In terms of cell size, a larger cell may be supported as a CP length increases, and thus, as a subcarrier spacing decreases, a relatively larger cell may be supported. A cell is a concept indicating an area covered by one BS in mobile communication.

The subcarrier spacing, the CP length, etc. are essential information for OFDM transmission and reception, and the BS and UE need to recognize such information as a common value to enable seamless transmission and reception.

Table 1 below shows a relationship among a subcarrier spacing configuration, a subcarrier spacing Δf, and a CP length supported in the 5G system.

TABLE 1

| | Δf = | |
|---|---|---|
| μ | 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

Table 2 below shows the number N_{symb}^{slot} of symbols per slot the number Nₛₗₒₜ^{frame,μ} of slots per frame, and the number Nₛₗₒₜ^{subframe,μ} of slots per subframe for each subcarrier spacing configuration in the case of a normal CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 below shows the number N_{symb}^{slot} of symbols per slot, the number Nₛₗₒₜ^{frame,μ} of slots per frame, and the number Nₛₗₒₜ^{subframe,μ} of slots per subframe for each subcarrier spacing configuration μ in the case of an extended CP.

TABLE 3

| μ | N_{symb}^{slot} | Nₛₗₒₜ^{frame, μ} | Nₛₗₒₜ^{subframe, μ} |
|---|---|---|---|
| 2 | 12 | 40 | 4 |

At an early stage of introduction of the 5G system, coexistence or dual mode operation with the existing LTE and/or LTE-A (hereinafter referred to as LTE/LTE-A) system is expected. As a result, the existing LTE/LTE-A may provide a stable system operation to the UE, and the 5G system may provide enhanced services to the UE. Therefore, a frame structure of the 5G system needs to include at least a frame structure or an essential parameter set (e.g., subcarrier spacing=15 kHz) of the existing LTE/LTE-A.

For example, when comparing the frame structure with subcarrier spacing configuration μ=0 (hereinafter referred to as frame structure A) and the frame structure with subcarrier spacing configuration μ=1 (hereinafter referred to as frame structure B), in the frame structure B compared to the frame structure A, the subcarrier spacing and a size of an RB are increased to be twice as large, and a slot length and a symbol length are decreased to be twice as small. In case of frame structure B, two slots may constitute one subframe, and 20 subframes may constitute one frame.

When the frame structure of the 5G system is normalized, a subcarrier spacing, a CP length, a slot length, and the like, which are an essential parameter set, may have the integer-multiple relation therebetween according to each frame structure, so as to provide high scalability. To indicate a reference time unit unrelated to the frame structure, a subframe having a fixed length of 1 ms may be defined.

The frame structure may be applied to correspond to various scenarios. In view of a cell size, when a CP length is increased, a larger cell may be supported, and thus the frame structure A may support a relatively large cell, compared to the frame structure B. In view of an operating frequency band, when subcarrier spacing is increased, it is advantageous for recovery of phase noise of a high frequency band, and thus the frame structure B may support a relatively high operating frequency, compared to the frame structure A. In view of a service, since a shorter length of a slot serving as a basic time unit for scheduling is more advantageous to support an ultra-low latency service such as URLLC, the frame structure B may be more appropriate for the URLLC service as compared to the frame structure A.

In an initial access stage in which the UE accesses a system for the first time, the UE may perform cell search to synchronize DL time and frequency and obtain a cell identity (ID) from a synchronization signal transmitted by the BS. The UE may use the obtained cell ID to receive a PBCH, and obtain a master information block (MIB) that is essential system information from the PBCH. In addition, the UE may receive system information (e.g., a system information block (SIB)) transmitted by the BS to obtain cell-common transmission/reception related control information. The cell-common transmission/reception related control information may include RA related control information, paging related control information, common control information regarding various physical channels, etc.

A synchronization signal is used as a reference for the cell search, and a subcarrier spacing may be applied to the synchronization signal for each frequency band and to be suitable for a channel environment, e.g., phase noise. For a data channel or a control channel, subcarrier spacings may be adaptively applied depending on a service type to support various services as described above.

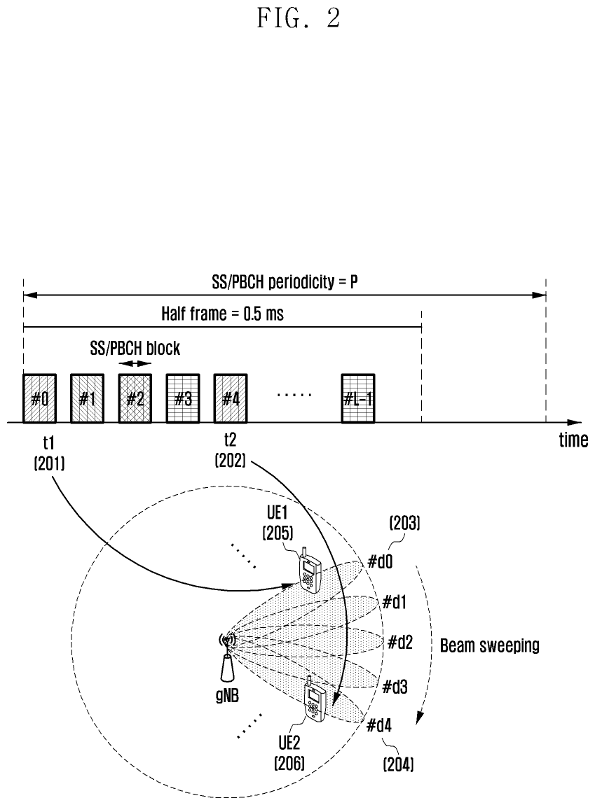

FIG. 2 illustrates a time domain mapping structure and a beam sweeping operation for a synchronization signal according to an embodiment.

Hereinafter, the following components may be defined for description of the disclosure.

A primary synchronization signal (PSS) is a signal used as a reference for DL time/frequency synchronization, and may provide some information of cell ID.

A secondary synchronization signal (SSS) is used as a reference for DL time/frequency synchronization and may provide remaining information of cell ID. The SSS may also serve as a reference signal for demodulation of a PBCH A PBCH may provide an MIB that is essential system information needed for the UE to transmit and receive a data channel and a control channel. The essential system information may include search space related control information indicating radio resource mapping information of a control channel, scheduling control information of a separate data channel for transmitting system information, information such as a system frame number (SFN) that is an index in a frame level that becomes a timing reference

A synchronization signal/PBCH block or SSB (SS/PBCH block) may be constituted with N OFDM symbols and may include a combination of the PSS, the SSS, the PBCH, and the like. For a system using a beam sweeping technology, an SS/PBCH block is the smallest unit for applying beam sweeping. In the 5G system, this unit may be N=4. The BS may transmit a maximum of L SS/PBCH blocks, and the L SS/PBCH blocks may be mapped within a half frame (0.5 ms). The L SS/PBCH blocks are periodically repeated in the unit of P, which is a predetermined periodicity. The BS may inform the UE of the periodicity P via signaling. When there is no separate signaling for the periodicity P, the UE may apply a predetermined default value.

Referring to FIG. 2, an example is given in which beam sweeping is applied in units of an SS/PBCH block over time. UE1 205 may receive an SS/PBCH block via a beam radiated in direction #d0 203 due to beamforming applied to SS/PBCH block #0 at a time point t1 201. UE 2 206 may receive an SS/PBCH block via a beam radiated in direction #d4 204 due to beamforming applied to SS/PBCH block #4 at a time point t2 202. The UE may obtain, from the BS, an optimal synchronization signal through a beam radiated in the direction in which the UE is located. For example, UE #1 205 may have difficulty in obtaining time/frequency synchronization and necessary system information from the SS/PBCH block through the beam radiated in direction #d4, far away from the location of UE 1 (e.g., beyond a certain threshold).

In addition to the initial access procedure, the UE may receive an SS/PBCH block to determine whether a radio link quality of a current cell is maintained at a certain threshold level or greater. Furthermore, in a handover procedure in which the UE moves access from the current cell to a neighboring cell, the UE may receive an SS/PBCH block of the neighboring cell to determine a radio link quality of the neighboring cell and obtain time/frequency synchronization of the neighboring cell.

After the UE obtains MIB and system information from the BS through the initial access procedure, the UE may perform an RA procedure to switch a link with the BS to a connected state (or RRC_CONNECTED state). Upon completion of the RA procedure, the UE transitions to a connected state (or RRC_CONNECTED state), and one-to-one communication is enabled between the BS and the UE.

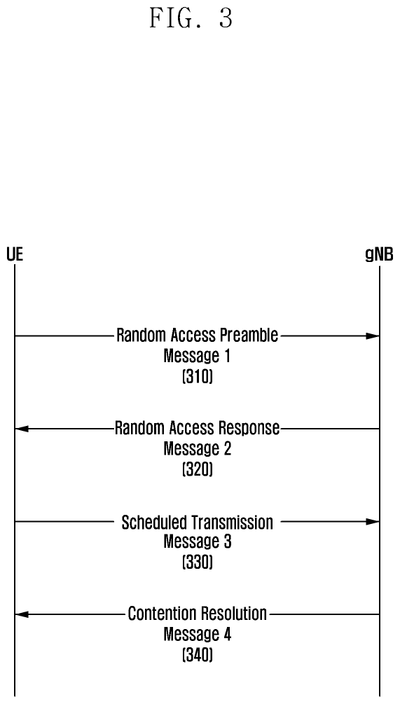

FIG. 3 illustrates a signal flow for RA according to an embodiment. The disclosure is not limited to the 4-step RA procedure illustrated in FIG. 3, and may also be applied to a 2-step RA procedure (transmitting and receiving message A (a message including information corresponding to message 1 and message 3) and transmitting and receiving message B (a message including information corresponding to message 2 and message 4)).

Referring to FIG. 3, in step 310, a UE may transmit an RA preamble to a BS. In the RA procedure, an RA preamble, which is a first message transmitted by the UE, may be referred to as Message 1. The BS may measure a transmission delay value between the UE and the BS from the RA preamble and achieve UL synchronization. In this case, the UE may randomly select an RA preamble to use from a set of RA preambles given by system information in advance. An initial transmission power for the RA preamble may be determined according to a pathloss between the BS and the UE, which is measured by the UE. The UE may transmit the RA preamble by determining a direction of a transmission beam for the RA preamble based on a synchronization signal received from the BS.

In step 320, the BS may transmit an RA response (RAR, or message 2) for the RA preamble received in step 310. The BS may transmit, to the UE, a UL transmission timing adjustment command based on the transmission delay value measured from the RA preamble. The BS may transmit, to the UE, UL resource to be used by the UE and power control commands as scheduling information. The scheduling information transmitted by the BS may include control information regarding a UL transmission beam of the UE.

When the UE does not receive, from the BS, an RAR (or message 2) that is scheduling information for message 3 within a certain time period in step 320, the UE may perform operation 310 again. When the UE performs operation 310 again, the UE may transmit the RA preamble with transmission power increased by a certain operation (e.g., power ramping), thereby increasing the probability of reception of the RA preamble at the BS.

In step 330, the UE may transmit UL data (i.e., message 3) including its UE ID to the BS by using the UL resource allocated in step 320. The UE may transmit UL data including UE ID to the BS through a UL data channel (a physical UL shared channel (PUSCH). A transmission timing of the UL data channel for transmitting message 3 may follow the timing control command received from the BS in step 320. A transmission power for the UL data channel for transmitting message 3 may be determined by considering the power control command received from the BS in step 320 and a power ramping value of the RA preamble. The UL data channel for transmitting message 3 may indicate a first UL data signal transmitted by the UE to the BS after the UE transmits the RA preamble.

In step 340, when the BS determines that the UE has performed the RA without colliding with another UE, the BS may transmit data (i.e., message 4) including an ID of the UE that has transmitted the UL data in step 330 to the UE. When the UE receives a signal transmitted by the BS in step 340, the UE may determine that the RA is successful. The UE may transmit, to the BS, hybrid automatic repeat request acknowledgement (HARQ-ACK) information indicating whether message 4 has been successfully received through a physical UL control channel (PUCCH).

When the data transmitted by the UE in step 330 collides with data transmitted by another UE and thus the BS fails to receive a data signal from the UE, the BS may no longer transmit data to the UE. When the UE fails to receive the data transmitted by the BS in step 340 within a certain time period, the UE may determine that the RA procedure has failed and restart the RA procedure from step 310.

When the UE has successful completed the RA procedure, the UE may transition to a connected state (or RRC_CONNECTED state), and one-to-one communication between the BS and UE is enabled. The BS may receive UE capability information from the UE in the connected state (or RRC_CONNECTED state) and adjust scheduling based on the UE capability information of the corresponding UE. The UE may inform, via the UE capability information, the BS of whether the UE itself supports a certain functionality, a maximum allowable value of the functionality supported by the UE, etc. Accordingly, the UE capability information reported by each UE to the BS may have a different value for each UE.

As an example, the UE may report, to the BS, UE capability information including at least one of the following control information.

Control information related to a frequency band supported by the UE

Control information related to a channel bandwidth supported by the UE

Control information related to a highest modulation scheme supported by the UE

Control Information related to a maximum number of beams supported by the UE

Control information related to a maximum number of layers supported by the UE

Control information related to CSI reporting supported by the UE

Control information about whether the UE supports frequency hopping

Control information related to a bandwidth when CA is supported

Control information about whether cross carrier scheduling is supported when CA is supported

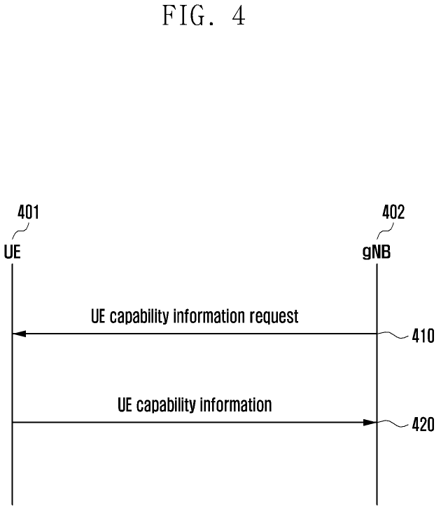

FIG. 4 illustrates a signal flow for reporting UE capability information by a UE to a BS according to an embodiment.

Referring to FIG. 4, in step 410, a BS 402 may transmit a UE capability information request message to a UE 401. Based on the request for UE capability information from the BS 402, the UE 401 may transmit UE capability information to the BS in step 420. The UE 401 may transmit the UE capability information to the BS 402 regardless of the request for UE capability information from the BS 402.

Based on the transmission and reception process of the UE capability information, the UE connected to the BS is in the RRC_CONNECTED state, and the UE connected to the BS may perform one-to-one communication. Conversely, a UE that is not connected is in the RRC IDLE state, and the UE in RRC_IDLE state may perform the following processes.

### Operation of a UE-Specific Discontinuous Reception (DRX) Cycle Configured by a Higher Layer Signaling Information

Reception of a Paging Message from a Core Network
obtaining system information.

Serving cell (or a cell on which to camp) related measurement operation and cell selection/reselection.

Neighboring cell related measurement operation and cell selection/reselection.

### Paging Early Indication (PEI) Reception

Higher layer signaling information may correspond to at least one or a combination of one or more of a MIB, SIB or SIB X (X=1, 2, . . . ), RRC information, and a MAC CE.

In addition, the layer 1 (L1) signaling information may correspond to at least one or more of physical layer channels or signaling methods including a physical DL control channel (PDCCH), DCI, UE-specific DCI, group common DCI, and common DCI.

Herein, information transmitted and received between the BS and the UE by higher layer signaling information may also be transmitted and received by various combinations of higher layer signaling information and/or L1 signaling information.

With respect to measurement operations related to a serving cell (or a cell on which to camp) and cell selection/reselection, the UE may measure synchronization signal-reference signal received power (SS-RSRP) and SS-RSRP level at least every M1*N1 DRX cycle for the serving cell (or the cell on which to camp), and evaluate the cell selection criterion S based on the measured values. Here, when the SSB-based measurement timing configuration (SMTC) cycle is greater than 20 ms and the DRX cycle is less than or equal to 0.64 s, M1=2, and in other cases, M1=1.

N1 can be determined as shown below in Table 4.

TABLE 4

| | N1 | | | |
|---|---|---|---|---|
| DRX cycle[s] | FR1 | FR2-1 | FR2-2 | Nₛₑᵣᵥ [number of DRX cycles] |
| 0.32 | 1 | 8 | 12 | M1*N1*4 |
| 0.64 | | 5 | 8 | M1*N1*4 |
| 1.28 | | 4 | 6 | N1*2 |
| 2.56 | | 3 | 5 | N1*2 |

The cell selection criterion S can be satisfied when Sᵣₓₗₑᵥ>0 corresponding to SS-RSRP and S_{qual}>0 corresponding to synchronization signal-reference signal received quality (SS-RSRQ) in Equation (1) below.

$${S}_{rxlev} = {Q}_{rxlevmeas} - ( {Q}_{rxlevmin} + {Q}_{rxlevminoffset} ) - {P}_{compensation} - {Q}_{offsettemp} \qquad ( 1 )$$

$${S}_{qual} = {Q}_{qualmeas} - ( {Q}_{qualmin} + {Q}_{qualminoffset} ) - {Q}_{offsettemp}$$

In Equation (1), Qᵣₓₗₑᵥₘₑₐₛ is the measured SS-RSRP, Q_{qualmeas} is the measured SS-RSRQ, Qᵣₓₗₑᵥₘᵢₙ is the minimum required reception signal level in the serving cell and can be received by the UE as system information, and Q_{qualmin} is the minimum required reception signal quality level in the serving cell and can be received by the UE as system information. The description of the parameters can be found as shown below in Table 5.

TABLE 5

| | |
|---|---|
| Srxlev | Cell selection RX level value (dB) |
| Squal | Cell selection quality value (dB) |
| Qoffsetₜₑₘₚ | Offset temporarily applied to a cell as specified in TS 38.331 [3] (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE supports SUL |
| | frequency for this cell, Qᵣₓₗₑᵥₘᵢₙ is obtained from q-RxLevMinSUL, if |
| | present, in SIB1, SIB2 and SIB4, additionally, if Q_{rxlevminoffsetcellSUL} is |
| | present in SIB3 and SIB4 for the concerned cell, this cell specific offset |
| | is added to the corresponding Qrxlevmin to achieve the required |
| | minimum RX level in the concerned cell; |
| | else Qᵣₓₗₑᵥₘᵢₙ is obtained from q-RxLevMin in SIB1, SIB2 and SIB4, |
| | additionally, if Q_{rxlevminoffsetcell} is present in SIB3 and SIB4 for the |
| | concerned cell, this cell specific offset is added to the corresponding |
| | Qrxlevmin to achieve the required minimum RX level in the concerned |
| | cell. |
| Q_{qualmin} | Minimum required quality level in the cell (dB). Additionally, if |
| | Q_{qualminoffsetcell} is signaled for the concerned cell, this cell specific offset |
| | is added to achieve the required minimum quality level in the |
| | concerned cell. |
| Q_{rxlevminoffset} | Offset to the signaled Qᵣₓₗₑᵥₘᵢₙ considered in the Srxlev evaluation as a |
| | result of a periodic search for a higher priority PLMN while camped |
| | normally in a VPLMN, as specified in TS 23.122 [9]. |
| Q_{qualminoffset} | Offset to the signaled Q_{qualmin} considered in the Squal evaluation as a |
| | result of a periodic search for a higher priority PLMN while camped |
| | normally in a VPLMN, as specified in TS 23.122 [9]. |
| P_{compensation} | For FR1, if the UE supports the additionalPmax in the NR-NS- |
| | PmaxList, if present, in SIB1, SIB2 and SIB4: |
| | max(P_{EMAX1} − P_{PowerClass}, 0) − (min(P_{EMAX2}, P_{PowerClass}) − min(P_{EMAX1}, |
| | P_{PowerClass})) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, P_{EMAX2} | Maximum TX power level of a UE may use when transmitting on the |
| | UL in the cell (dBm) defined as P_{EMAX} in TS 38.101 [15]. If UE |
| | supports SUL frequency for this cell, P_{EMAX1} and P_{EMAX2} are obtained |
| | from the p-Max for SUL in SIB1 and NR-NS-PmaxList for SUL |
| | respectively in SIB1, SIB2 and SIB4 as specified in TS 38.331 [3], else |
| | P_{EMAX1} and P_{EMAX2} are obtained from the p-Max and NR-NS-PmaxList |
| | respectively in SIB1, SIB2 and SIB4 for normal UL as specified in TS |
| | 38.331 [3]. |
| P_{PowerClass} | Maximum RF output power of the UE (dBm) according to the UE |
| | power class as defined in TS 38.101-1 [15]. |

The UE may determine the SS-RSRP of the serving cell by filtering from at least two measurement values that are separated by at least half a DRX cycle in determining the measured SS-RSRP. In addition, the UE may determine the SS-RSRQ of the serving cell by filtering from at least two measurement values that are separated by at least half a DRX cycle in determining the measured SS-RSRQ.

If the UE determines that the serving cell does not satisfy the cell selection criterion S during consecutive DRX cycles of the Nₛₑᵣᵥ, the UE may initiate measurement of all neighboring cells other than the serving cell. When the UE fails to find a new suitable cell for 10 s, the UE may initiate a cell selection procedure for the selected public land mobile network (PLMN).

More specifically, with respect to the measurement operation related to the neighboring cells and the cell reselection, if the UE determines that the serving cell does not satisfy the cell selection criterion S during the consecutive DRX cycles of the Nₛₑᵣᵥ, the UE may initiate the measurement of all neighboring cells other than the serving cell. When the UE fails to find a new suitable cell for 10 s, the UE may initiate the cell selection procedure for the selected PLMN.

After the UE initiates the measurement of the neighboring cells, the UE may measure the SS-RSRP and SS-RSRQ levels for each Tₘₑₐₛᵤᵣₑ and evaluate whether the neighboring g cells satisfy the cell reselection criterion within each Tₑᵥₐₗᵤₐₜₑ. The newly detected cell may be evaluated for whether it satisfies the cell reselection criterion within each T_{detect}. During T_{reselection}, when the neighboring cell is better than the serving cell according to the cell reselection criterion and at the same time, more than 1 second has passed since the UE camped on the current serving cell, the UE may reselect the neighboring cell as the new serving cell. Parameters such as Tₘₑₐₛᵤᵣₑ, Tₑᵥₐₗᵤₐₜₑ, and T_{reselection} may be determined in the standard according to the DRX cycle, or may be configured by a higher signal. The UE may determine the SS-RSRP of the neighboring cell by filtering from at least two measurement values that are separated by at least half of Tₘₑₐₛᵤᵣₑ when determining the measured SS-RSRP.

The cell reselection criterion may determine the cell selection order based on Rₛ and Rₐ calculated by the following parameters. That is, the cell ranking may be determined as shown below in Equation (2) in the order of high values across Rₛ and Rₙ.

$${R}_{s} = {Q}_{meas , s} + {Q}_{hyst} - {Qoffset}_{temp} {R}_{n} = {Q}_{meas , n} - Qoffset - {Qoffset}_{temp} \qquad ( 2 )$$

In Equation (2), Q_{meas,s} and Q_{meas,n} represent RSRP measurement values of the serving cell and neighboring cells, respectively, and Q_{hyst}, Qoffset, Qoffsetₜₑₘₚ and the like may be configured by a higher signal.

With respect to the neighboring cell measurement, it is possible to stop the neighboring cell measurement when a specific condition is satisfied, or to perform the neighboring cell measurement with a period longer than Tₘₑₐₛᵤᵣₑ. When the UE is moving slowly or stopped within the cell, or when it is determined that the UE is not at the cell boundary, the UE may perform the neighboring cell measurement with a period longer than Tₘₑₐₛᵤᵣₑ multiplied by a scaling factor, or may stop the neighboring cell measurement for up to 1 hour.

With respect to receiving a paging message from the core network, the UE (i.e. the UE equipped with only a main radio) may monitor one PO during a DRX cycle. A PO is a set of PDCCH monitoring occasions and may include multiple time slots (subframes or OFDM symbols) in which paging control information may be received. A PF is one radio frame (10 ms) and may include one or more POs or starting points of POs.

PF and PO and the SFN for PF may be determined as shown below in Equation (3).

$$( SFN + PF\_offset ) mod T = ( T div N ) * ( UE\_ID mod N ) \qquad ( 3 )$$

In Equation (3), PF_offset is an offset for PF determination, T is a DRX cycle, N is the number of (cell common, i.e., cell-specific) PFs per DRX cycle, which is determined by higher layer signaling information, and UE_ID is a UE ID (5G-S-temporary mobile subscriber identity (TMSI)) determined by the core network. The PFs determined by the above N mean PFs commonly applied to UEs in a cell, and are referred to as cell-common PFs (cell specific PFs) in the disclosure.
i_s, which indicates the PO index, is determined as shown below in Equation (4).

$$i\_s = floor ( UE\_ID / N ) mod Ns \qquad ( 4 )$$

In Equation (4), Nₛ indicates the number of POs in one PF and is determined by higher layer signaling information as one of the integer values such as 1, 2, 4, . . . .

As an example, when PF_offset=3, T=128, N=T/4=32, Ns=4, and UE_ID mod 32 is 1, and floor (UE_ID/32) mod 4 is 1, in Equation (3) and Equation (4), SFN for PF and i_s indicating PO index within the PF may be determined as shown below in Equation (5).

$$( SFN + 3 ) mod 128 = ( 128 div 32 ) * ( UE\_ID mod 32 ) = 4 * 1 = 4 , i\_s = floor ( UE\_ID / 32 ) mod 4 = 1 \qquad ( 5 )$$

Therefore, the PF, which is a PF that the UE with the above UE_ID must receive, is determined as a radio frame with SFN of 1, 129, 257, . . . among the cell-common PFs (Cell specific PFs), and the PO may be determined as the (i_s+1)th PO (the 2nd PO in the above example) among the 4 POs in the PF. The PO represents a set of PDCCH monitoring occasions (e.g., “SxX” consecutive PDCCH monitoring occasions). The above “S” is the number of actual transmitted SSBs determined according to the ssb-positionsinburst information, which indicates the time domain positions of SSB(s) transmitted in the half frame with the SS/PBCH block provided through the RRC information in the NR standard, and the above “X” may be “1” in the general case.

PEI was introduced to reduce the UE power consumed while monitoring and receiving the paging control channel and paging data channel in each DRX cycle. The UE may monitor or receive one PEI opportunity (PEI occasion, PEI-O) before receiving paging during the DRX cycle. When the UE receives PEI and the PEI indicates the paging reception subgroup to which the UE belongs, the UE may monitor the associated PO. When the UE does not detect a PEI in a PEI opportunity or the PEI does not indicate a paging reception subgroup to which the UE belongs, the UE does not need to monitor the associated PO, thereby reducing UE power consumption. The UE may determine the PEI opportunity in the following manner. A PEI opportunity, which is a radio frame of a reference point that is located ahead by pei-FrameOffset from a PF including the associated PO, is as far back as subframe offset, and the UE may monitor the PEI in the PEI opportunity determined in the above manner. The pei-FrameOffset, subframe offset, etc. may be determined by higher layer signaling information.

To reduce the energy and time consumed for initial access of a UE in the 5G system, a new UE state called RRC_INACTIVE is defined. In addition to the operations performed by an RRC_IDLE UE, an RRC_INACTIVE UE may perform the following operations.

Access stratum (AS) information storage operation required for cell access

UE-specific DRX cycle operation configured by an RRC layer

RNA (radio access network (RAN)-based notification area) configuration and periodic update operation that may be utilized during handover by an RRC layer

RAN-based paging message monitoring operation transmitted through inactive-radio network temporary identifier (I-RNTI)

A UE in the RRC_CONNECTED state may change from RRC_CONNECTED to RRC_INACTIVE and RRC_IDLE states by receiving an RRC Release indication from the BS.

A UE in RRC_INACITVE, RRC_IDLE state may change from RRC_INACTIVE, RRC_IDLE state to RRC_CONNECTED state by performing RA and completing all RA procedures.

A scheduling method for transmitting DL data to the UE or indicating the UE to transmit UL data by the BS will be described below.

DCI is control information that a BS transmits to a UE on the DL and may include DL data scheduling information or UL data scheduling information for a predetermined UE. The BS may independently channel-encode DCI for each UE and then transmit the DCI to each UE on a PDCCH.

The BS may apply a predetermined DCI format and operate the DCI format for the UE to be scheduled, depending on the purpose of the DCI such as whether the DCI is scheduling information for DL data (a DL assignment), whether the DCI is scheduling information for UL data (a UL grant), or whether the DCI is for power control.

The BS may transmit DL data to the UE via a PDSCH, which is a physical channel for DL data transmission. The BS may indicate scheduling information such as specific mapping positions in the time and frequency domains, a modulation scheme, hybrid automatic repeat request (HARQ)-related control information, and power control information for the PDSCH to the UE by DCI related to DL data scheduling information among DCIs transmitted via the PDCCH.

The UE may transmit UL data to the BS on a PUSCH, which is a physical channel for UL data transmission. The BS may indicate scheduling information such as specific mapping positions in the time and frequency domains, a modulation scheme, HARQ-related control information, and power control information for the PUSCH to the UE by DCI related to UL data scheduling information among DCIs transmitted on the PDCCH.

The time-frequency resources to which the PDCCH is mapped may be referred to as a control resource set (CORESET). The CORESET may be configured to all or part of the frequency resources of the bandwidth supported by the UE in the frequency domain. In the time domain, it may be configured to one or more OFDM symbols, which may be defined as the CORESET duration. The BS may configure one or a plurality of CORESETs to the UE through a higher layer signaling (e.g., system information, MIB, RRC signaling, etc.). Configurating the CORESET to the UE by the BS refers to providing information such as a CORESET identity, a frequency position of the CORESET, and a symbol length of the CORESET. The information provided to the UE by the BS to configure the CORESET may include some information about the information as shown in Table 6 below.

TABLE 6

| | |
|---|---|
| ControlResourceSet ::= | SEQUENCE { |
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6}, |
| shiftIndex | INTEGER(0..maxNrofPhysicalResourceBlocks-1) |

OPTIONAL -- Need S
},

| | |
|---|---|
| nonInterleaved | NULL |

},

| | |
|---|---|
| precoderGranularity | ENUMERATED {sameAsREG-bundle, allContiguousRBs}, |
| tci-StatesPDCCH-ToAddList | SEQUENCE(SIZE (1..maxNrofTCI-StatesPDCCH)) |

OF TCI-StateId OPTIONAL, -- Cond NotSIB1-initialBWP

| | |
|---|---|
| tci-StatesPDCCH-ToReleaseList | SEQUENCE(SIZE (1..maxNrofTCI-StatesPDCCH)) OF |

TCI-StateId OPTIONAL, -- Cond NotSIB1-initialBWP

| | | |
|---|---|---|
| tci-PresentInDCI | ENUMERATED {enabled} | OPTIONAL, -- |

Need S

| | | |
|---|---|---|
| pdcch-DMRS-ScramblingID | INTEGER (0..65535) | OPTIONAL, -- |

Need S
}

A CORESET may be constituted with N_{RB}^{CORESET} RBs in the frequency domain and N_{symb}^{CORESET}∈{1, 2, 3} symbols in the time domain. The NR PDCCH may include one or a plurality of control channel elements (CCEs). One CCE may be constituted with six resource element groups (REGs), and an REG may be defined as one RB during one OFDM symbol. In one CORESET, REGs may be indexed in time-first order, starting with REG index 0 from the lowest RB in the first OFDM symbol of the CORESET.

An interleaved scheme and non-interleaved scheme may be supported to transmit a PDCCH. The BS may configure for the UE whether to transmit the PDCCH in the interleaved or non-interleaved scheme on each CORESET by higher layer signaling. Interleaving may be performed in units of an REG bundle. An REG bundle may be defined as a set of one or a plurality of REGs. The UE may determine a CCE-to-REG mapping scheme for a corresponding CORESET based on the interleaved or non-interleaved transmission scheme configured by the BS in the same manner as shown below in Table 7.

TABLE 7
The CCE-to-REG mapping for a control-resource set can be interleaved or non-interleaved
and is described by REG bundles:

| | |
|---|---|
| - | REG bundle i is defined as REGs {iL,iL + 1,...,iL + L − 1} where L is the REG |
| | bundle size, i = 0, 1, ... , N_{REG}^{CORESET}/L − 1 and N_{REG}^{CORESET} = N_{RB}^{CORESET}N_{symb}^{CORESET} is |
| | the number of REGs in the CORESET |
| - | CCE j consists of REG bundles {f(6j/L),f(6j/L + 1),...,f(6j/L + 6/L − 1)} |
| | where f(·)is an interleaver |

```
For non-interleaved CCE-to-REG mapping, L = 6 and f(x) = x.
For interleaved CCE-to-REG mapping, L ∈ {2, 6}for N_{symb}^{CORESET} = 1 and L ∈
{N_{symb}^{CORESET}, 6} for N_{symb}^{CORESET} ∈ {2, 3}. The interleaver is defined by
    f(x) = (rC + c + n_{shift}) mod (N_{REG}^{CORESET}/L)
          x = cR + r
        r = 0, 1, ... , R − 1
        c = 0, 1, ... , C − 1
      C = N_{REG}^{CORESET}/(LR)
where R ∈ {2,3,6}.
```

The BS may indicate configuration information such as information about a symbol to which the PDCCH is mapped in a slot and a transmission period of the PDCCH to the UE by signaling.

The search space of PDCCH is described as follows. The number of CCEs required to transmit a PDCCH may be 1, 2, 4, 8, or 16 according to an aggregation level (AL), and different numbers of CCEs may be used for link adaptation of a DL control channel. For example, in case of AL=L, one DL control channel may be transmitted in L CCEs. When the UE does not know information about the DL control channel, the UE performs blind decoding which detects a signal. For the blind decoding, a search space being a set of CCEs may be defined. The search space is a set of DL control channel candidates constituted with CCEs that the UE should attempt to decode at a given AL. There are various ALs at which 1, 2, 4, 8, and 16 CCEs are bundled to form one bundle, and thus the UE may have a plurality of search spaces. A search space set may be defined as a set of search spaces for all configured ALs.

Search spaces may be classified into a common search space (CSS) and a UE-specific search space (USS). A certain group of UEs or all UEs may search the CSS of a PDCCH to receive cell-common control information such as dynamic scheduling of an SIB or a paging message. For example, the UE may receive scheduling allocation information about a PDSCH for system information reception by searching the CSS of the PDCCH. In the case of the CSS, since a certain group of UEs or all UEs should receive the PDCCH, the CSS may be defined as a set of predetermined CCEs. The UE may receive scheduling allocation information about a UE-specific PDSCH or PUSCH by searching the USS of the PDCCH. The USS may be UE-specifically defined by a function of a UE ID and various system parameters.

The BS may configure configuration information about a search space of a PDCCH for the UE through higher layer signaling (e.g., an SIB, an MIB, or RRC signaling). For example, the BS may configure the UE with the number of PDCCH candidate groups for each AL L, the monitoring periodicity of a search space, a monitoring occasion in a symbol unit of a slot for the search space, a search space type (CSS or USS), a combination of a DCI format and an RNTI to be monitored in the corresponding search space, and a CORESET index to be monitored in the search space. For example, parameters for a PDCCH search space may include information shown below in Table 8.

TABLE 8

| SearchSpace ::= | SEQUENCE { | |
|---|---|---|
| searchSpaceId | SearchSpaceId, | |
| controlResourceSetId | ControlResourceSetId | OPTIONAL, -- Cond |

SetupOnly
monitoringSlotPeriodicityAndOffset CHOICE {

| sl1 | NULL, | |
|---|---|---|
| sl2 | INTEGER (0..1), | |
| sl4 | INTEGER (0..3), | |
| sl5 | INTEGER (0..4), | |
| sl8 | INTEGER (0..7), | |
| sl10 | INTEGER (0..9), | |
| sl16 | INTEGER (0..15), | |
| sl20 | INTEGER (0..19), | |
| sl40 | INTEGER (0..39), | |
| sl80 | INTEGER (0..79), | |
| sl160 | INTEGER (0..159), | |
| sl320 | INTEGER (0..319), | |
| sl640 | INTEGER (0..639), | |
| sl1280 | INTEGER (0..1279), | |
| sl2560 | INTEGER (0..2559), | |
| } | | OPTIONAL, -- Cond Setup |
| duration | INTEGER (2..2559) | OPTIONAL, -- Need R |
| monitoringSymbolsWithinSlot | BIT STRING (SIZE (14)) | OPTIONAL, -- |

Cond Setup

| nrofCandidates | SEQUENCE { | |
|---|---|---|
| aggregationLevel1 | ENUMERATED {n0, n1, n2, n3, n4, n5, n6, n8}, | |
| aggregationLevel2 | ENUMERATED {n0, n1, n2, n3, n4, n5, n6, n8}, | |
| aggregationLevel4 | ENUMERATED {n0, n1, n2, n3, n4, n5, n6, n8}, | |
| aggregationLevel8 | ENUMERATED {n0, n1, n2, n3, n4, n5, n6, n8}, | |
| aggregationLevel16 | ENUMERATED {n0, n1, n2, n3, n4, n5, n6, n8}, | |
| } | | OPTIONAL, -- Cond Setup |

| | |
|---|---|
| searchSpaceType | CHOICE { |
| common | SEQUENCE { |
| dci-Format0-0-AndFormat1-0 | SEQUENCE { |

...

| } | | OPTIONAL, -- Need R |
|---|---|---|
| dci-Format2-0 | SEQUENCE { | |
| nrofCandidates-SFI | SEQUENCE { | |
| aggregationLevel1 | ENUMERATED {n1, n2} | OPTIONAL, -- Need |

R

| | | |
|---|---|---|
| aggregationLevel2 | ENUMERATED {n1, n2} | OPTIONAL, -- Need |

R

| | | |
|---|---|---|
| aggregationLevel4 | ENUMERATED {n1, n2} | OPTIONAL, -- Need |

R

| | | |
|---|---|---|
| aggregationLevel8 | ENUMERATED {n1, n2} | OPTIONAL, -- Need |

R

| | | |
|---|---|---|
| aggregationLevel16 | ENUMERATED {n1, n2} | OPTIONAL -- Need |

```
R
        },
        ...
```

| | |
|---|---|
| } | OPTIONAL, -- Need R |

| | |
|---|---|
| dci-Format2-1 | SEQUENCE { |

...

| | |
|---|---|
| } | OPTIONAL, -- Need R |

| | |
|---|---|
| dci-Format2-2 | SEQUENCE { |

...

| | |
|---|---|
| } | OPTIONAL, -- Need R |

| | |
|---|---|
| dci-Format2-3 | SEQUENCE { |
| dummy1 | ENUMERATED {sl1, s12, s14, s15, s18, s110, sl16, s12} |

OPTIONAL, -- Cond Setup

| | |
|---|---|
| dummy2 | ENUMERATED {n1, n2}, |

...

| | |
|---|---|
| } | OPTIONAL -- Need R |

},

| | |
|---|---|
| ue-Specific | SEQUENCE { |
| dci-Formats | ENUMERATED {formats0-0-And-1-0, formats0-1-And- |

```
1-1},
      ...,
    }
```

| | |
|---|---|
| } | OPTIONAL -- Cond Setup2 |

}

Based on the configuration information that the BS transmits to the UE, the BS may configure one or a plurality of search space sets for the UE. The BS may configure search space set 1 and search space set 2 for the UE. In search space set 1, the UE may be configured to monitor DCI format A scrambled with an X-RNTI in a CSS, and in search space set 2, the UE may be configured to monitor DCI format B scrambled with a Y-RNTI in a USS.

According to the configuration information transmitted by the BS, one or a plurality of search space sets may exist in the CSS or USS. For example, search space set #1 and search space set #2 may be configured as the CSS, and search space set #3 and search space set #4 may be configured as the USS.

In the CSS, the UE may monitor the following combinations of DCI format and RNTI, but the disclosure is not limited thereto.

DCI format 0_0/1_0 with CRC scrambled by C-RNTI, CS-RNTI, SP-CSI-RNTI, RA-RNTI, TC-RNTI, P-RNTI, SI-RNTI

DCI format 2_0 with CRC scrambled by SFI-RNTI

DCI format 2_1 with CRC scrambled by INT-RNTI

DCI format 2_2 with CRC scrambled by TPC-PUSCH-RNTI, TPC-PUCCH-RNTI

DCI format 2_3 with CRC scrambled by TPC-SRS-RNTI

In the USS, the UE may monitor the following combinations of DCI format and RNTI but the disclosure is not limited thereto.

DCI format 0_0/1_0 with CRC scrambled by C-RNTI, CS-RNTI, TC-RNTI

DCI format 1_0/1_1 with CRC scrambled by C-RNTI, CS-RNTI, TC-RNTI

RNTIs may follow the following definitions and uses but the disclosure is not limited thereto.

Cell RNTI (C-RNTI): purpose for UE-specific PDSCH or PUSCH scheduling

Temporary cell RNTI (TC-RNTI): purpose for UE-specific PDSCH scheduling

Configured scheduling RNTI (CS-RNTI): purpose for semi-statically configured UE-specific PDSCH scheduling

RA-RNTI: purpose for PDSCH scheduling in the RA stage

Paging RNTI (P-RNTI): purpose for PDSCH scheduling for paging transmission

System information RNTI (SI-RNTI): purpose for PDSCH scheduling through which system information transmission is transmitted

Interruption RNTI (INT-RNTI): purpose for indicating whether PDSCH is punctured

Transmit power control for PUSCH RNTI (TPC-PUSCH-RNTI): purpose for indicating power control command for PUSCH

Transmit power control for PUCCH RNTI (TPC-PUCCH-RNTI): purpose for indicating power control command for PUCCH

Transmit power control for SRS RNTI (TPC-SRS-RNTI): purpose for indicating power control command for SRS

The above-described DCI formats may follow the definitions shown below in Table 9.

TABLE 9

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

A search space for an AL L in a CORESET p and a search space set s may be expressed in Equation (6) below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i \qquad ( 6 )$$

L: Aggregation level
nCI: Carrier index
NCCE,p: The number of total CCEs present in the CORESET p
nμs,f: slot index
M(L)p,s,max: The number of PDCCH candidates of aggregation level L
msnCI=0, . . . , M(L)p,s,max−1: Index of PDCCH candidates of aggregation level L
i=0, . . . , L−1

$${Y}_{p , {n}_{s , f}^{μ}} = ( {A}_{p} \cdot {Y}_{p , {n}_{s , f}^{μ} - 1} ) mod D ,$$

$${Y}_{p , - 1} = {n}_{RNTI} \neq 0 ,$$

$${A}_{0} = 39827 ,$$

$${A}_{1} = 39829 ,$$

$${A}_{2} = 398 \; 39 ,$$

$$D = 65 \; 537$$

nRNTI: UE identity

The value of Y_{p,n}_{_{s,f}}_{^{μ}} may correspond to 0 in the case of CSS

The value of Y_{p,n}_{_{s,f}}_{^{μ}} may correspond to a value changed according to a UE ID (a C-RNTI or an ID configured for the UE by the BS) and a time index in the case of USS

Herein, higher layer signaling (a higher signal, higher signaling) may be signaling corresponding to at least one of MIB, SIB or SIB X (X=1, 2, . . . ), RRC, and MAC CE.

In addition, L1 signaling may be signaling corresponding to at least one of signaling methods using the physical layer channels or signaling below or a combination of one or more of a PDCCH, DCI, UE-specific DCI, group common DCI, common DCI, scheduling DCI (e.g. DCI used for scheduling DL data or UL data), non-scheduling DCI (e.g. DCI not for scheduling DL data or UL data), a PUCCH, and UL control information (UCI).

The above examples are described through a plurality of embodiments, but these are not independent and one or more embodiments may be applied simultaneously or in combination.

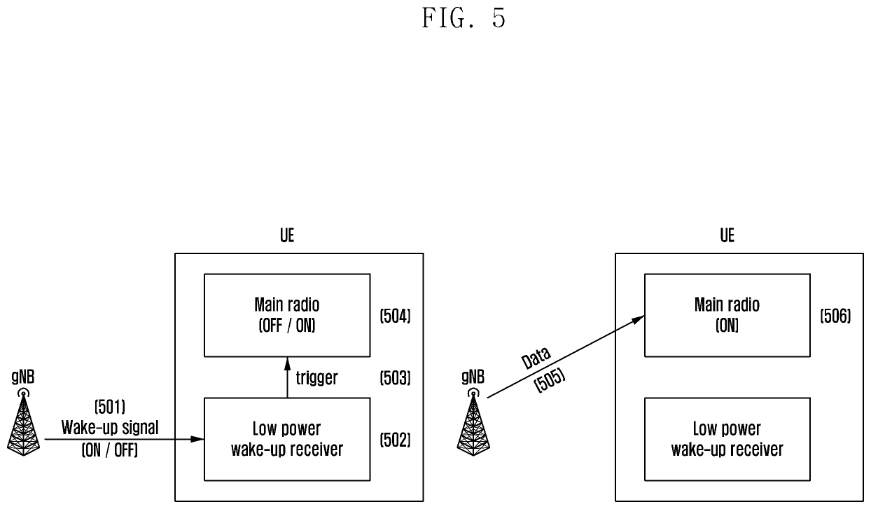

FIG. 5 illustrates state transitions between a BS and a UE and a state of a UE according to a BS state, according to an embodiment. Referring to FIG. 5, state transitions are described between a BS and a UE

A 5G UE (or a UE beyond 5G) may need to wake up periodically once per eDRX cycle, which may dominate power consumption during periods when there is no signaling or data traffic between the UE and the BS. If the UE may wake up only when triggered, such as by paging, power consumption may be drastically reduced. A groundbreaking power consumption reduction scheme may be achieved by triggering a main radio (e.g., an existing NR radio) using a WUS, as illustrated in FIG. 5, and using a separate receiver, a WUR, that may monitor the WUS with ultra-low power to turn on the main radio only when data transmission and reception are required. The main radio and WUR may include at least one of a transceiver included in the UE for transmitting and receiving radio signals, a modem for encoding/decoding the transmitted and received signals, and a component(s) that consumes power within the UE. Alternatively, the main radio and WUR may be understood as the UE itself, in which case the UE may operate so as to consume only the minimum power required for receiving the WUS until the WUS is received.

In step 501, the BS may transmit a WUS corresponding to ON or OFF to the UE. The BS may transmit the WUS to the UE, and the WUS may include ON information or OFF information. The WUS indicating ON may trigger an ON state in which the main radio operates, and the WUS indicating OFF may trigger an OFF state in which the main radio does not operate (or operates minimally). Alternatively, the WUS may indicate an ON state in which the main radio operates, and the UE that has received the paging by receiving the WUS may perform an operation according to the paging and then switch the main radio back to the OFF state without receiving the WUS indicating the OFF state of the main radio or a separate signal.

In step 502, the UE may receive the WUS from the BS using a WUR (or low power WUR).

In step 503, the UE may trigger the main radio to the OFF or ON state based on information indicating that the received WUS corresponds to ON or OFF. For example, triggering the main radio may indicate triggering a state transition for the main radio. For example, it may be a trigger for switching the main radio from OFF to ON, or a trigger for switching the main radio from ON to OFF.

In step 504, the UE may wake up the main radio or configure the main radio to a power-off state based on the WUS. For example, configuring the main radio to a power-off state may indicate that the main radio is completely turned off. Alternatively, as an optional embodiment, the main radio may be configured to a deep sleep (DS) or ultra deep sleep (UDS) state rather than a completely OFF state, based on the WUS. Whether the main radio is completely OFF, DS, or UDS may be distinguished based on which components within the main radio may be turned off. For example, when the main radio is completely OFF, all components within the main radio may be OFF. When the main radio is in the DS state, the oscillator, radio frequency-front end (RF-FE), and baseband modem may be OFF, while the control processor and double data rate (DDR) memory may still be ON. When the main radio is in the UDS state, the oscillator, RF-FE, and baseband modem may be OFF, and the control processor and DDR memory may also operate at very low power (e.g., lower than a certain threshold) or be OFF. The power consumption of the main radio decreases in the order of DS state=>UDS state=>OFF state.

In step 505, when data traffic to be transmitted from the BS to the UE occurs and the WUS transmitted by the BS in step 501 is a signal corresponding to ON, in step 506, the main radio of the UE may be ON, and the UE may receive the data transmitted by the BS through the main radio, not the WUR. That is, when the BS transmits the WUS corresponding to ON in step 501, the main radio of the UE may be ON. The BS may transmit data in step 505, and the UE may receive data via the main radio in step 506.

The power consumption for monitoring the WUS depends on the hardware modules of the WUR used for designing the WUS, and detecting and processing signals, so that the benefits may be maximized for IoT use cases (such as industrial sensors, controllers) and various devices including wearable devices (such as a foam factor device that is power consumption sensitive and compact).

The UE including the WUR may report to the BS that it has the ability to wake up the main radio using the WUR, or report capability information that the UE includes the WUR to the BS.

The UE may also report capability information about the WUR to the BS through the UE capability information reporting procedure in FIG. 4.

Referring back to FIG. 4, a UE that has received a request for UE capability information from a BS in step 410 may transmit, to the BS, UE capability information including capability information about a WUR in step 420. Alternatively, even when there is no request from the BS in step 410, it may be possible for the UE to provide capability information about the WUR to the BS.

In the RA procedure of steps 310 to 340 in FIG. 3, the UE may report capability information about the WUR to the BS through step 310 of transmitting an RA preamble or step 330 of transmitting a scheduled transmission (message 3) according to the RA procedure on an UL data channel. Information about sets of RA preambles that the UE including a WUR may transmit may be transmitted to the UE through higher layer signaling information. The UE may select an RA preamble from among the sets received by the UE, and may transmit the RA preamble in step 310 based on the selected RA preamble. After reporting capability information about a WUR to the BS, the UE may receive information indicating whether to use the WUR from the BS through higher layer signaling information or L1 signaling information.

When the BS supports the UE including a WUR (for example, a case where the BS includes hardware capable of transmitting a WUS), the BS may determine whether to use the WUR after receiving capability information about the WUR from the UE. The BS may transmit, to the UE, higher layer signaling information and/or L1 signaling information including whether to use the WUR or configuration information for receiving the WUS. The BS may transmit, to the UE, at least one of indication information for UE reception of the WUS or activating the WUR and indication information for notifying that the BS transmits the WUS. For example, after a slot configured by the BS (or defined in the 3GPP standard) from a slot in which the UE WUS is received, the UE may turn off the main radio and turn on the WUR for monitoring the WUS. Prior to turning off the main radio, the UE may transmit, to the BS, at least one of feedback information indicating that the WUS indicating whether to use the WUR has been received and feedback information indicating that the main radio has been turned off and the WUR has been turned on.

When the BS does not support the UE including the WUR, the BS may receive capability information about the WUR from the UE and then transmit, to the UE, a signal indicating that the WUR is unusable. In this case, the UE may transmit, to the BS, that the feedback information indicating that the signal indicating that the WUR was unusable has been received. The UE may perform an operation according to parameters of the existing power saving method configured by the BS using the existing power saving method (connected mode DRX (C-DRX) or idle mode DRX (I-DRX) such as paging) proposed in the 3GPP standard.

The UE may determine whether to activate or deactivate the WUR based on reception of the WUS transmitted from the BS or based on reception of a synchronization signal of the WUR transmitted from the BS. In the above, based on the reception of the signal means that the determination is made based on the result value obtained by measuring the quality of the signal or a metric value such as the reception error rate of the signal, and the determination may be performed by comparing with a specific value defined in the standard or comparing with a threshold value received as a higher signal from the BS.

After the procedure for reporting the capability of the UE including the WUR and receiving information about whether the BS supports (or permits) the WUR, the WUR of the UE may perform an operation of turning on and off the main radio of the UE based on the WUS. The UE may independently perform the operation to turn the main radio on/off and the operation of reporting the capability of the UE including the WUR or the procedures for receiving information about whether the WUR is supported from the BS. For example, even when the capability report operation of the UE and the authorization procedure for use of the WUR from the BS are not performed, the BS may transmit, to the UE, a signal indicating whether the WUR is used or configuration information for receiving the WUS. Accordingly, the UE including the WUR among the UEs receiving the signal from the BS may perform on/off of the main radio through the WUR.

After the capability report operation of the UE and the authorization procedure for use of the WUR from the BS are performed, the operation of performing on/off of the main radio through the WUR may be applied to all UEs or part of all UEs within the cell supported by the BS (e.g., RRC_CONNECTED UEs, RRC_IDLE/RRC_INACTIVE UEs, or UEs connecting to the cell (e.g., RRC_CONNECTED UEs)). When the UE capability reporting operation and BS authorization procedure are not performed, the operation of turning the main radio on/off via the WUR may be applied to RRC_IDLE/RRC_INACTIVE UEs that camp on within the cell supported by the BS.

Hereinafter, the disclosure may include at least one of all, some, or a combination of parts of various operations of the UE including the WUR and the BS supporting such a UE.

An operation of turning on and off the main radio of the UE including the WUR is now described.

When the main radio of the UE is on, the UE may receive a DL signal (or data) from the BS via the main radio. According to various embodiments of the disclosure, the main radio being on may be expressed as the main radio being turned on or the main radio being activated, and the on or off of the main radio (or transceiver) is not limited thereto and may have a similar or substantially equivalent meaning. The activation of the main radio may indicate that all or at least some of specific components of the main radio (e.g., RF or baseband (BB), etc.) are turned on or activated, or may be defined by the relevant standard. However, the activation of the main radio may include performing an operation by a parameter or parameters having equivalent or substantially similar contents thereto.

Alternatively, the activation of the main radio may include the main radio performing a reception operation of a specific channel or signal (e.g., an SS/PBCH block including a synchronization signal or a PDCCH including a DL control channel) defined in the relevant standard.

When the main radio of the UE is off, the UE may be considered to be in a sleep period or may not receive a DL signal (or data) from the BS. Herein, the main radio being ‘off’ may be expressed as the main radio being ‘turned off’ or the main radio being ‘deactivated’, and may have a similar or substantially equivalent meaning thereto, without limited thereto.

The main radio being deactivated may indicate that all or at least some of specific components of the main radio (e.g., RF or BB, etc.) are turned off or deactivated, or may be defined by the relevant standard. However, the main radio being deactivated may include performing an operation by a parameter or parameter having equivalent or substantially similar content thereto. Alternatively, the main radio being deactivated may include the main radio no longer performing reception operations for specific channels or signals (e.g., SS/PBCH blocks including synchronization signals or PDCCH including DL control channels) defined in the 3GPP TS document.

To reduce power consumption in the UE, when the UE receives the WUS from the BS (or when receiving the WUS indicating an on state), the main radio may be triggered to turn on via the WUR so that the main radio may receive DL signals from the BS, and when the WUS is not received (or when the WUS indicating an off state is received) the main radio may be turned off. Alternatively, the on/off operation of the main radio based on the reception of the WUS may also be applied to the RA procedure and UL transmission of the UE.

In this case, the UE in the RRC IDLE or RRC INACTIVE state may attempt to receive paging immediately upon receiving the WUS while skipping the reception of the PEI described above. Herein, the operation for determining the PO and PF may be performed in the same manner at the BS transmitting the paging and the UE receiving the paging. In addition, the transmission and reception of the paging in the disclosure may be understood as the transmission and reception of the paging message.

The operations or procedures described herein as being performed by the main radio or WUR for the UE equipped with the WUR (i.e., the UE including the ability of wake-up reception) may also be understood as being performed by the UE including the WUR (i.e., the UE including the ability of wake-up reception).

For example, receiving a signal/channel by the wake-up may be understood that the UE (and/or the processor included in the UE) receives the signal/channel through the WUR (or by using the WUR). And/or performing measurement by the WUR may be understood that the signal/channel, etc. for measurement is received through the WUR, and the UE (and/or the processor included in the UE) performs the measurement operation based on the reception.

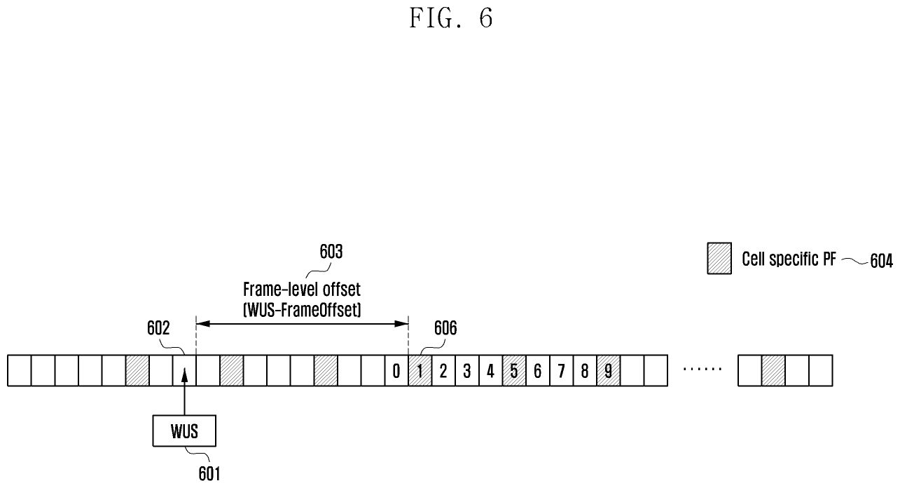

In FIGS. 6 to 8 below, the reception of the WUS by the UE may be understood as the UE receiving the WUS indicating the on state of the main radio for convenience of explanation.

The BS may transmit paging from one PF determined based on the transmission of the WUS, and the UE may receive paging from one PF determined based on the reception of the WUS. Alternatively, the BS may transmit paging from a plurality of PFs determined based on the transmission of the WUS, and the UE may receive paging from a plurality of PFs determined based on the reception of the WUS. The number of the plurality of PFs may be limited to a predetermined number in consideration of the power consumption of the UE.

Information provided via higher layer signaling information may also be provided via a combination of at least one of the aforementioned higher layer signaling information and L1 signaling information.

FIG. 6 illustrates a paging reception scheme of a UE including a WUR according to an embodiment.

Referring to FIG. 6, a scheme is given for determining a PF of a UE including a WUR within the number of cell-common PFs (cell specific PFs) per N, that is, DRX cycle, and transmitting and receiving paging in the above PF. Through this scheme, the UE may receive paging immediately without additional delay after receiving the WUS.

Since PFs of all or a predetermined group of UEs in a cell including the UE including the WUR may be supported within the number of cell-common PFs, there is no need for additional resources due to the introduction of additional PFs of the UE including the WUR, and there is an advantage that the complexity of scheduling of the BS does not increase due to paging support for the UE including the WUR.

In FIG. 6, cell-common PFs (cell specific PFs) are depicted by the shading of reference number 604, and an SFN in which the WUS 601 is received, i.e., a radio frame (602), is depicted. Based on the radio frame 602 in which the WUS 601 is received, a WUS-FrameOffset 603 may be added/configured to determine a PF. That is, the PF may be determined with a time difference of WUS-FrameOffset 603 at the frame level based on the radio frame 602.

The WUS-FrameOffset 603 may be determined by considering the time required for the WUR of the UE to receive the WUS 601, wake up the main radio (to operate in an ON state) based on the WUS 601, and for the main radio to receive a paging signal, and the WUS-FrameOffset 603 may be received by higher layer signaling information. Alternatively, the WUS-FrameOffset 603 may be included in the WUS 601 and may be received by the UE. When the PF determined by the method based on the WUS and WUS-FrameOffset is not included in the cell common PF 604, the PF may be determined as the next cell common PF that exists next The embodiment in FIG. 6 assumes, for convenience, a case of UE_ID where PF_offset=3, T=128, N=T/4=32, Ns=4, and UE_ID mod 32 is 1, and floor (UE_ID/32) mod 4 is 1, as assumed in the explanation of Equation (3) and Equation (4). The cell common PFs 604, which are SFNs of every fourth radio frame, i.e., . . . , −3, 1, 5, 9, . . . , by N=T/4 and PF_offset=3 are depicted by shading. In the NR system, radio frames may be configured in a round robin scheme from 0 to 1023, and since the radio frame following above 1023 repeats numbers starting from 0 to 1023, radio frame −3 in the above indicates radio frame 1021 (=−3 mod 1024).

When the PF determined by adding/configuring WUS-FrameOffset 603 based on the radio frame 602 in which the WUS 601 is received is 1, the UE may determine SFN=1 as the PF (i.e. PF=1) 606 that must receive paging.

When the PF determined by adding/configuring the WUS-FrameOffset 603 based on the radio frame 602 in which the WUS 601 is received is the case of SFN=2, which does not belong to the cell common PF, the UE may determine the next cell common PF, SFN=5, as the PF at which the UE should receive paging. Since the PF according to the conventional scheme described above is determined as a radio frame with SFN=1, 129, 257, . . . by (SFN+3) mod 128=(128 div 32)*(UE_ID mod 32)=4*1=4, for example, the conventional scheme cannot determine SFN=5 as the PF. Therefore, compared to the conventional scheme in which the next PF is 129, according to the method in FIG. 6, the UE may quickly receive paging.

The UE may not expect that the PF that should receive the paging determined by the method of FIG. 6 is not included in the cell common PF. That is, the above UE may expect that the PF determined by the method of FIG. 6 is always included in the cell common PF. Accordingly, the BS may perform scheduling so that the PF determined by the method of FIG. 6 is always included in the cell common PF.

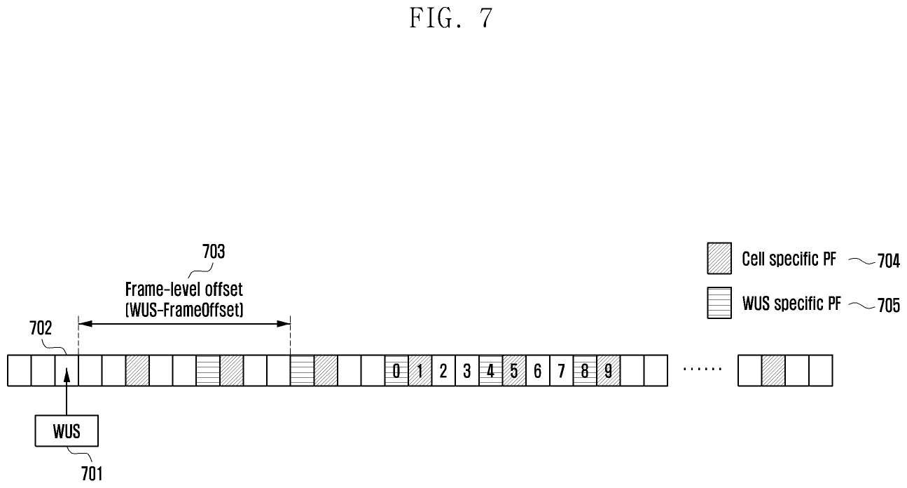

FIG. 7 illustrates a paging reception scheme of the UE including the WUR according to an embodiment.

Referring to FIG. 7, discloses a scheme is given for determining a PF of the UE including the WUR among the remaining radio frames excluding N, i.e., the number of cell-common PFs per DRX cycle (cell specific PF), and transmitting and receiving paging in the above PF. Through this scheme, the UE may receive paging immediately without additional delay after receiving the WUS.

In FIG. 7, paging for the UE including the WUR may be supported among the remaining radio frames excluding the number of cell-common PFs applied to existing UEs in the cell, so that it is possible to eliminate the impact on paging resources for existing UEs due to paging support for the UEs including the WUR.

In FIG. 7, the cell common PF (cell-specific PF) 704 and the WUS specific PF 705 are depicted with distinct shades. Also, FIG. 7 illustrates a radio frame 702 of an SFN in which a WUS 701 is received.

Based on the radio frame 702 in which the WUS 701 is received, a WUS-FrameOffset 703 may be added/configured to determine a PF. That is, the PF may be determined with a time difference of the WUS-FrameOffset 703 at the frame level based on the radio frame 702. The above WUS-FrameOffset 703 may be determined by considering the time required for the WUR of the UE to receive the WUS 701, wake up the main radio (to operate in an on state) based on the WUS 701, and for the main radio to receive a paging signal. The above WUS-FrameOffset 703 may be received by higher layer signaling information. Alternatively, the above WUS-FrameOffset 703 may be included in the WUS 701 and received by the UE.

In FIG. 7, the PF may be determined from among the remaining radio frames except for the cell common PF 704. As a method for determining the remaining radio frames (hereinafter referred to as WUS specific PF 705), the UE supporting the WUR may receive information about a set(s)/list of WUS specific PF 705 by higher layer signaling information, and to determine the system frame number (SFN) for the PF in the example of FIG. 7, a separate offset may be applied to the cell common PF 704 calculated using the existing scheme (SFN+PF_offset) mod T=(T div N)*(UE_ID mod N) of Equation (3).

The separate offset may be provided to the UE supporting the WUR by higher layer signaling information. Alternatively, a formula in which some parameters in Equation (3) are changed to parameters for the UE supporting the WUR may be used. For example, in the UE supporting the WUR instead of the existing PF_offset, the offset PF_offset_WUS for PF determination may be provided to the UE through higher layer signaling information. In this case, Equation (3) may be newly defined as in Equation (7) below.

$$( SFN + PF\_offset \_WUS ) mod T = ( T div N ) * ( UE\_ID mod N ) \qquad ( 7 )$$

In FIG. 7, when the PF determined by the method of determining the PF by adding/configuring the WUS-FrameOffset 703 based on the radio frame 702 in which the above WUS 701 is received is the cell common PF 704, the PF may be determined from the WUS specific PF 705 that exists next.

FIG. 7 assumes, for convenience, a case of UE_ID where PF_offset=3, T=128, N=T/4=32, Ns=4, UE_ID mod 32 is 1, and floor (UE_ID/32) mod 4 is 1.

With respect to FIG. 7, a case where the cell common PF 704 is the SFN of every fourth radio frame, i.e., . . . , −3, 1, 5, 9, . . . by N=T/4 and PF_offset=3 is illustrated. In the NR system, the radio frame may be configured from 0 to 1023 in a round robin scheme, and since the radio frame following 1023 repeats numbers starting from 0 to 1023, the radio frame −3 in the above indicates radio frame 1021 (=−3 mod 1024). In addition, as an example, assuming that the PF_offset_WUS received by the UE is “0”, the WUS specific PF 705 configured as the SFN of every fourth radio frame, i.e., . . . , −4, 0, 4, 8, . . . , by N=T/4 and PF_offset_WUS=0 in the above Equation (7) is illustrated.

In FIG. 7, when the PF determined by adding/configuring WUS-FrameOffset 703 based on the radio frame 702 in which the WUS 701 is received, and to satisfy Equation (7) is SFN=−4 (i.e., the case of 1020 (=−4 mod 1024)) 707, the UE may determine SFN=−4 707 in the WUS specific PF 705 as the PF that must receive paging. In addition, when the PF determined by adding/configuring the WUS-FrameOffset based on the radio frame 702 in which the WUS 701 is received is 1, the UE may determine 4, which is the next WUS specific PF 705, as the PF that the UE must receive paging. For example, the PF according to the conventional scheme described above is determined as the radio frame of which SFN is 1, 129, 257, . . . , by (SFN+3) mod 128=(128 div 32)*(UE_ID mod 32)=4*1=4, compared to the disclosed method where the next PF is 129, the disclosed method enables the UE to quickly receive paging.

The UE may not expect that the PF that should receive the paging determined by the method of FIG. 7 is not included in the WUS specific PF 705. That is, the UE may expect that the PF determined by the method of FIG. 7 is always included in the WUS specific PF 705. Therefore, the BS may perform scheduling so that the PF determined by the method of FIG. 7 is always included in the WUS specific PF.

In this case, a situation may occur in which the UE including the WUR has received, from the BS, an indication to use the WUR, or the UE has determined to activate the WUR based on reception of the WUS transmitted from the BS and then the WUR cannot normally receive the WUS, or a situation may occur in which the UE cannot normally receive the WUS using the WUR. For example, there may be a situation in which it is difficult for the UE to receive the WUS, such as a case where the UE has moved to a cell boundary or a case where the channel condition is poor. In this case, the UE may determine to receive a signal from the BS using only the main radio without using the WUR. In this case, there may be problems in which the BS cannot know whether the UE including the WUR actually determines the PF based on the schemes of FIGS. 6 and 7 using the WUR and receives the paging through the determined PF, or determines the PF based on the paging reception scheme of the existing UE (i.e., the UE equipped only with the main radio) described in the disclosure by using the main radio without using the WUR, and receives the paging through the determined PF. In this case, the BS may have to transmit a paging message to the UE including the WUR in duplicates in the PF determined based on the schemes of FIGS. 6 and 7 and in the PF based on the paging reception scheme of the existing UE. Therefore, a problem may occur in that the amount of resources required to transmit a paging message for one UE is twice that of the existing UE.

Two schemes for solving the above problem will be described.

As a first scheme, the BS may indicate the UE including the WUR to transmit a paging message in the PF determined based on the existing UE's paging reception scheme or to transmit the paging message in the PF determined based on the schemes of FIGS. 6 and 7. Through the above indication, the BS may adjust the amount of resources required to transmit the paging message to the UE including the WUR. The above indication may be received by the UE including the WUR through a higher signal or system information, or may be received by the UE including the WUR through a WUS or a synchronization signal specific to the WUR transmitted to achieve the synchronization of the WUR.

As a second scheme, the BS may transmit a paging message to the UE including the WUR in the PF determined based on the existing UE's paging reception scheme. This scheme enables the BS to transmit a single paging message to the UE including the WUR like the existing UE. However, since the PO for transmitting the paging message is determined based on the UE ID and the modulo formula regardless of whether the UE includes the WUR or an existing UE, the paging messages of the UE including the WUR and existing UE may be mixed in one PO. In this case, the BS cannot operate separately for the UE including the WUR and the existing UE, and even when a system information update is required only for the existing UE (for example, a system information update related to PEI), the paging message including the system information update is received by all UEs in the IDLE/INACTIVE state within the cell. Therefore, a problem may occur in that the UE including the WUR must unnecessarily turn on the main radio to receive the paging message. In addition, even when the system information update is required only for the UE including the WUR (for example, the system information update related to information related to the WUR, WUS, or WUR specific synchronization signal), the paging message including the system information update is received by all UEs in the IDLE/INACTIVE state within the cell. Therefore, a problem may occur where existing UEs must unnecessarily turn on the main radio to receive the paging message.

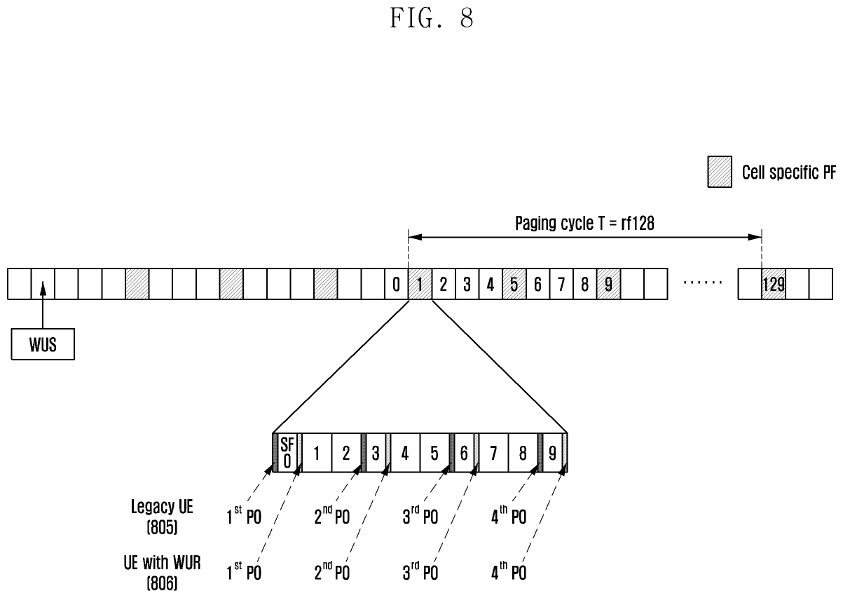

A first embodiment for solving the above issue will be described in reference to FIG. 8.

FIG. 8 illustrates a paging reception scheme of a UE including a WUR according to an embodiment.

Referring to FIG. 8, a scheme is disclosed for introducing a separate PO for a UE including a WUR, which is different from the PO determined for an existing UE.

The PO of the existing UE may be determined by the following scheme.

Among the Ns number of POs, the PO 805 of the existing UE determines which PO 805 will receive the paging message by the index of the POs 805 i_s=floor (UE_ID/N) mod Ns, where Ns indicates the number of POs in one PF and is determined by higher layer signaling information. The example of FIG. 8 shows a case where Ns=4, i.e., four POs 805 are included in one PF.

The UE including the WUR may determine the PO 806 by using the following scheme.

In a first method, the determination of PO 806 may apply different parameters than those of the existing legacy UE that does not include the WUR. For example, instead of Ns applied to the existing UE, Ns_WUS applied to the UE including the WUR may be introduced. For example, it may be determined by the index of the PO 806, i_s=floor (UE_ID/N) mod Ns_WUS. Here, Ns_WUS indicates the number of POs in one PF of the UE(s) including the WUR and may be determined/configured by higher layer signaling information. The Ns_WUS and Ns may be configured to different values or the same value. The example of FIG. 8 shows a case where Ns_WUS=4, that is, four POs 806 are included in one PF.

In a second method, the determination of PO may be applied in the same manner as the existing legacy UE including no WUR, but new additional parameters may be added/configured. The index of PO may be determined by i_s={floor (UE_ID/N) mod Ns_WUS}+Ns, where Ns indicates the number of POs in one PF of the existing UE and may be determined/configured by higher layer signaling information. Ns_WUS indicates the number of POs in one PF for the UE including the WUR and may be determined/configured by higher layer signaling information.

By the above formula of i_s=floor (UE_ID/N) mod Ns_WUS+Ns, the PO of the UE including the WUR may be located next to the PO of the existing UE, and the PO of the UE including the WUR and the PO of the existing UE may be separated. The above parameters may be transmitted by higher layer signaling information and received by the UE including the WUR.

The start position (OFDM symbol or subframe location) and the amount of resources in the time domain of PO resources corresponding to the above i_s may be transmitted via higher layer signaling information and received by the UE including the WUR.

The second embodiment for solving the above issue will be described.

The same PO as the PO of the existing UE may be indicated for the UE including the WUR but may be configured to receive a different PDCCH through a separate PDCCH configuration. Accordingly, it may be determined whether the UE including the WUR and the existing UE will receive a paging message by receiving different PDCCHs.

For example, the BS may indicate resource configuration for PDCCH reception for the UE including the WUR. The BS may indicate a separate pagingSearchSpace_WUS instead of the existing pagingSearchSpace in PDCCH-ConfigCommon. The pagingSearchSpace_WUS may be received by the UE including the WUR through a higher signal or system information from the BS.

Hereinafter, a procedure for waking up the main radio when the main radio is in a sleep state is described.

When there is a channel or signal to be transmitted to the UE, the BS may transmit a WUS to the UE. The UE or WUR may receive the WUS and turn on the main radio. The operation of receiving the WUS itself may be an indication to wake up the main radio. The WUS may include K information bits, and information to wake up the main radio may be mapped to the K information bits. For example, when the information bit included in the WUS is 1 bit of information, ‘1’ may indicate ON, and ‘0’ may indicate OFF. Conversely, ‘0’ may indicate ON, and ‘1’ may indicate OFF.

From a BS transmission perspective, whether to transmit a WUS at some point before transmission of a channel or signal may be predefined. From a UE reception perspective, whether to receive a WUS at some point before reception of a channel or signal may be predefined.

The UE may transmit, to the BS, information about a time offset required between the WUS and transmission of a channel/signal, and the BS may configure a time offset between the WUS and transmission of the channel/signal to the UE based on the received information. The UE may transmit, to the BS, information about a time offset required between the WUS and transmission of the channel/signal through a UE capability information report procedure, or through an RA preamble in an RA procedure or UL data channel. The disclosure is not limited thereto, and the UE may transmit information about the time offset to the BS through higher layer signaling information and/or through various signals and/or a combination of various signals.

The BS may configure information about the time offset between the transmission of the WUS and the channel/signal to the UE through the DL data channel of the RA response (e.g., message 2) or RA contention resolution (e.g., message 4) in the RA procedure. The BS may configure information about the time offset to the UE through higher layer signaling information and/or through various signals and/or combinations of various signals, without limitation thereto.

When the BS has a periodic channel or periodic signal to transmit to the UE, instead of transmitting the WUS every time the BS has a channel or signal to transmit, the UE or WUR may turn on the main radio according to the period according to the configuration information of the periodic channel or periodic signal configured by the BS.

The BS may transmit the WUS only during the first transmission of the periodic channel or periodic signal, and may omit transmission of the WUS during subsequent repetitive transmissions of the channel or signal. In this case, the UE or WUR may turn on the main radio based on the period according to the configuration information of the periodic channel or periodic signal configured by the BS.

The type of the periodic channel or periodic signal transmitted and received by the BS and UE may be predefined. The type of the periodic channel or periodic signal may be configured by the BS. For example, the BS may configure the type of the periodic channel or periodic signal to the UE through a DL data channel of an RAR (e.g., message 2) or RA contention resolution (e.g., message 4), or may configure the configuration information for receiving the WUS to the UE through higher layer signaling information and/or L1 signaling information.

When the UE includes a channel or signal (e.g., a physical RA channel (PRACH) or a scheduling request (SR) or a buffer status report (BSR)) to transmit to the BS, or when the UE performs layer 1/layer 3 (L1/L3)-based measurement, the UE or WUR may turn on the main radio regardless of the WUS transmitted by the BS.

For UL transmission or L1/L3-based measurement transmitted by the UE to the BS, the WUR may not apply an operation of receiving the WUS and turning on and off the main radio of the UE. That is, in this case, even in a situation where the WUS is not received, the WUR may turn on the main radio in advance by the configuring of the higher signal from the BS (the configuration of whether to turn on or off the main radio by the configuration of the resource related to the above UL or L1/L3-based measurement and transmission and reception thereof or by reception of the WUS, or the configuration of whether to turn on or off the main radio by the configuration of the above UL or L1/L3-based measurement regardless of whether the WUS is received), or the UE (or the main radio) may be in the on state in advance and may not be turned on by the WUS.

The type of the UL channel or UL signal of the UE transmitted regardless of the reception operation of the WUS or the L1/L3-based measurement may be defined in advance. The type of the UL channel or UL signal or the L1/L3-based measurement may be configured by the BS. For example, the BS may configure the UL channel or the type of UL signal or L1/L3-based measurement to the UE through a DL data channel of an RAR (e.g., message 2) or RA contention resolution (e.g., message 4), or may configure the same to the UE through higher layer signaling information and/or L1 signaling information indicating configuration information for reception of the WUS.

Herein, when the main radio is in an on state, the operation for waking up the main radio may be performed in combination with at least one of the various operations according to various embodiments of the disclosure in FIGS. 1 to 8, or may be performed separately, and may not be an essential component.

The BS may transmit a sleep signal to the UE when there is no channel or signal to be transmitted to the UE. The UE or WUR may receive the sleep signal and turn off the main radio. The operation of receiving the sleep signal itself may be an indication to make (or turn off) the main radio to sleep. The sleep signal may be configured as a separate sequence from the WUS. The sleep signal may include information that is mapped to information for making the main radio to sleep in the K information bits included in the WUS. For example, in the case of 1 bit of information, ‘0’ may indicate OFF and ‘1’ may indicate ON. For example, in the case of 1 bit of information, ‘1’ may indicate OFF and ‘0’ may indicate ON. That is, when an information bit included in a specific signal indicates OFF, the specific signal may be interpreted as a sleep signal, and when the information indicates ON, the specific signal may be interpreted as the WUS. That is, the sleep signal/WUS may be distinguished according to the information bit value within the same signal.

The main radio of the UE may be turned off when the configured condition is satisfied. For example, the condition configured for the main radio (the condition for the main radio to be turned off) may be the case where the main radio fails to detect or decode a DL control channel, a specific channel, or a signal during a configured period. The BS may configure the configuration information for the UE to determine the off of the main radio (e.g., information including a period and a specific channel or signal) through higher layer signaling information and/or L1 signaling information indicating the configuration information for receiving the WUS.

The main radio of the UE may always be turned off after receiving one channel or signal. According to an embodiment, after the WUR receives the WUS from the BS and the main radio is turned on to receive the channel or signal, the main radio may be turned off. The time required for the main radio to be turned off after the channel or reception is completed may be predefined. The UE may transmit information about the time required for the main radio to be turned off to the BS, and the BS may configure the required time to the UE based on the received information. The information about the required time transmitted by the UE may be transmitted to the BS through a UE capability information report procedure. The information about the required time transmitted by the UE may be transmitted to the BS through an RA preamble or an UL data channel. The UE may transmit information about the required time to the BS through higher layer signaling information. The BS may configure information about the required time to be transmitted to the UE through a DL data channel of an RAR (e.g., message 2) or RA contention resolution (e.g., message 4). Apparently, without limitation thereto, the BS may configure information about the required time to the UE through higher layer signaling information.

Hereinafter, when the UE or main radio of the UE is in an RRC_CONNECTED state, the UE may be configured to connected mode DRX (C-DRX) and perform PDCCH reception by waking up the main radio at every DRX cycle. When the UE or main radio of the UE is in an RRC_CONNECTED state, the UE (or the main radio) may be configured to receive a signal indicating whether the UE should receive PDCCH at the next DRX cycle.

When the main radio is in an RRC_IDLE/RRC_INACTIVE state, the UE may be configured to idle mode DRX (I-DRX) and receive paging PDCCH by waking up the main radio at every paging cycle. When the UE or main radio of the UE is in an RRC_CONNECTED state, the UE (or the main radio) may be configured to receive a signal indicating whether the UE should receive paging PDCCH at the next paging cycle.

Hereinafter, an embodiment of a procedure of the UE operating as the WUR when an operation in which ON/OFF is indicated based on reception of the WUS of the WUR and main radio and an operation according to the configuration of C-DRX or I-DRX are mixed is described.

An operation of the UE or main radio of the UE related to an RRC CONNECTED/IDLE/INACTIVE state may be performed in combination with at least one of the various operations according to various embodiments of the disclosure in FIG. 1 to 8, or may be performed separately, and may not be an essential component.

When the UE including the WUR performs an operation of turning on and off the main radio of the UE by receiving the WUS, the UE may not perform the configuration of C-DRX or I-DRX and the operation according to the configuration. In this case, instead of performing the C-DRX or I-DRX configuration and operation according to configuration, the UE may turn on the main radio of the UE only when it receives the WUS to wake up the main radio, and may receive a PDCCH and a PDSCH defined or configured to be received in the C-DRX or I-DRX, respectively.

When the UE or main radio of the UE is in the RRC_CONNECTED state and the operation performed by the WUR is configured or activated by the BS, the UE may turn on the main radio when the WUR receives the WUS to wake up the main radio, and may also perform an operation related to the C-DRX configured by the BS (e.g., the main radio may receive a PDCCH within drx_onDurationTimer for each DRX cycle). The UE (or the main radio) may not perform an operation configured to receive a signal (e.g., DCI format 2_6, WUS) indicating whether the UE should receive a PDCCH in the next DRX cycle.

When the UE or main radio of the UE is in an RRC_IDLE/INACTIVE state and an operation performed by the WUR is configured or activated by the BS, the UE may turn on the main radio when the WUR receives the WUS to wake up the main radio, and may also perform an operation related to the I-DRX configured by the BS (e.g., the main radio wakes up every paging cycle to receive a paging PDCCH). The UE (or the main radio) may not perform an operation configured to receive a signal (e.g., DCI format 2_7, paging early indication) indicating whether the UE should receive a paging PDCCH in the next paging cycle.

The UE may perform an operation for waking up the main radio according to the WUR and the WUS, and an operation for turning off the main radio, instead of an operation according to the configuration related to C-DRX or I-DRX. When the operation performed by the WUR is deactivated by the BS, the operations related to the C-DRX or I-DRX configured by the BS may be repeated. That is, the priority of the operation based on the WUS corresponding to the WUR may be higher than the priority of the operation according to the DRX configuration.

When the operation performed by the WUR of the UE is configured or activated by the BS, and the UE or WUR receives the WUS and the main radio is turned on, the UE may transition to the RRC_CONNECTED state or transition to the RRC_IDLE or RRC_INACTIVE state. Whether the UE may transition to a certain state may be determined in advance, or may be determined by higher layer signaling information and/or L1 signaling information regarding WUR operation configuration from the BS.

As an example of when information regarding a transition of the UE is determined in advance, the state of the main radio may follow the state of the most recent main radio just before the current on time in which the main radio turned on and then turned off. Alternatively, the state of the main radio may not be affected by whether the WUR operation is configured and activated. For example, the state of the main radio of the UE may be determined only by higher layer signaling information indicating at least one of RRC_CONNECTED, RRC_IDLE, and RRC_INACTIVE, and the UE may determine that the state of the main radio is not changed by whether the WUR operation is configured and activated.

The WUS may include K information bits, and information about at least one of whether the main radio is going to be (transition) to an RRC_CONNECTED state, an RRC_IDLE state, or an RRC_INACTIVE state may be mapped to the K information bits.

When the UE or main radio of the UE is in RRC_CONNECTED based on the determined state of the UE, the main radio may wake up and receive a PDCCH every DRX cycle by the C-DRX configured by the BS, or the UE (or the main radio) may be configured by the BS to receive a signal indicating to the UE whether to receive a PDCCH in the next DRX cycle. When an operation for turning off the main radio is performed while the UE is receiving a PDCCH (e.g., a period in which the PDCCH is received), the UE may first perform a procedure for turning off the main radio.

When the UE or main radio of the UE is in RRC_IDLE/INACTIVE, the main radio may wake up and receive the paging PDCCH at each paging cycle by the I-DRX configured by the BS. The UE (or the main radio) may also be configured by the BS to receive a signal indicating to the UE whether to receive the paging PDCCH in the next paging cycle. When an operation for turning off the main radio is performed while the UE receives the paging PDCCH (e.g., a period in which the paging PDCCH is received), the UE may perform the procedure for turning off the main radio with priority.

Operations of the UE (or the main radio or the WUR) described above may be performed regardless of the order, and it is apparent that the subject of the operation may be the UE or the main radio or the WUR.

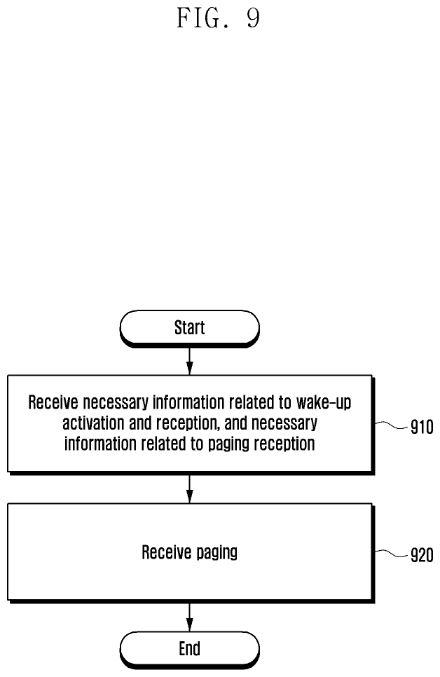

FIG. 9 illustrates a method for receiving paging by a UE including a WUR according to an embodiment.

In step 910, the UE may receive a wake-up activation signal or a wake-up deactivation signal. The UE may receive the wake-up activation signal from a BS to receive a WUS using the WUR according to at least one of the embodiments of the disclosure described above, or may receive the wake-up deactivation signal from the BS to no longer receive the WUS using the WUR. In addition, the UE may receive information necessary for receiving the WUS from the BS. The UE may receive, from the BS, a signal indicating whether to use the WUR or configuration information for receiving the WUS. In addition, the UE may receive information required to receive paging from the BS.

In step 920, the UE may receive paging according to at least one of the embodiments of the disclosure described above. The WUR is configured or activated and turned on to search for the WUS, and when the WUS is received, the paging may be received at a PF/PO determined according to at least one of the embodiments of the disclosure described above. In an embodiment, when the WUR is not configured or activated, the paging may be received at a PF/PO determined based on a paging reception scheme for legacy UEs.

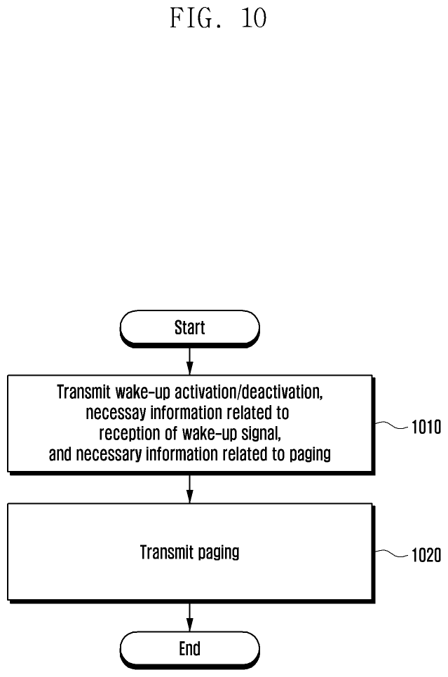

FIG. 10 illustrates a method of a BS for transmitting paging according to an embodiment. In step 1010, the BS may transmit a wake-up activation signal or a wake-up deactivation signal. The BS may transmit the wake-up activation signal to the UE so that the UE receives a WUS using the WUR according to at least one of the embodiments of the disclosure described above, or may transmit the wake-up deactivation signal to the UE so that the UE no longer receives the WUS using the WUR. In addition, the BS may transmit information necessary for receiving the WUS to the UE. The BS may transmit, to the UE, a signal indicating whether to use the WUR or configuration information for receiving the WUS. In addition, the BS may transmit information necessary for receiving the paging to the UE.

In step 1020, the BS may transmit the paging according to at least one of the embodiments of the disclosure described above. When the WUR is configured or activated and turned on to search for the WUS, and the WUS is transmitted so that the UE may receive the WUS, the BS may transmit the paging in the PF/PO determined according to at least one of the embodiments of the disclosure described above. When the BS does not configure or activate the WUR, the paging may be transmitted in the PF/PO determined based on the paging reception scheme for the legacy UEs.

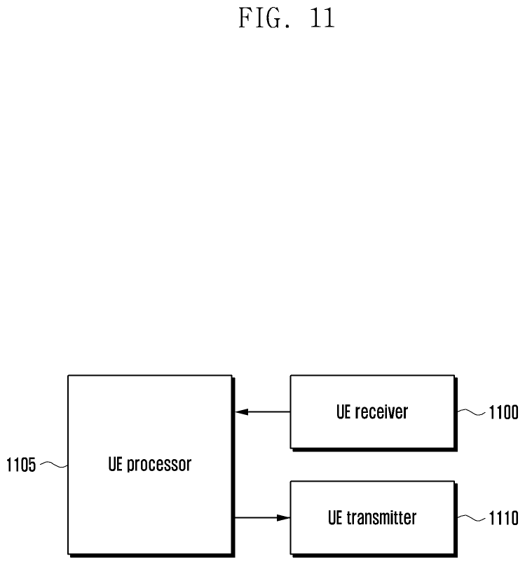

FIG. 11 illustrates a structure of a UE in a wireless communication system according to an embodiment.

Referring to FIG. 11, the UE may include a transceiver referred to as a UE receiver 1100 and a UE transmitter 1110, a memory (not illustrated), and a UE processor 1105 (or a UE controller or processor). According to the above described communication method of the UE, the UE transceiver 1100, 1110, the memory, and the UE processor 1105 may operate. However, the components of the UE are not limited to the above described examples. For example, the UE may include more or fewer components than the aforementioned components. Furthermore, the transceiver, memory, and processor may be implemented with a single chip.

The transceiver may transmit and receive a signal to and from the BS. Herein, the signal may include control information and data. To do this, the transceiver may include an RF transmitter for up-converting and amplifying a frequency of a transmitted signal, an RF receiver for low-noise-amplifying a received signal and down-converting a frequency of the received signal, and the like. However, this is only an embodiment of the transceiver, and the components of the transceiver are not limited to the RF transmitter and RF receiver.

The transceiver may receive a signal via a radio channel, output the signal to the processor, and transmit the signal outputted from the processor via a radio channel.

The memory may store a program and data necessary for the operation of the UE. In addition, the memory may store control information or data included in the signal transmitted and received by the UE. The memory may be configured with a storage medium such as a read only memory (ROM), a random access memory (RAM), a hard disk, a compact disc (CD)-ROM and a digital versatile disc (DVD), or a combination thereof. In addition, the memory may be in plural.

In addition, the processor may control a series of processes to operate the UE according to the above-described embodiments of the disclosure. For example, the processor may control the component of the UE to receive DCI constituted with two layers and thus concurrently receive a plurality of PDSCHs. The processor may be in plural, and the processor may execute the program stored in the memory to thus control the component of the UE.

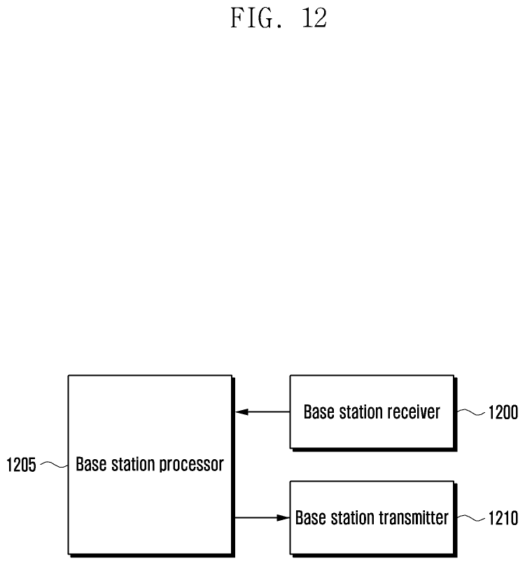

FIG. 12 illustrates a structure of a BS in a wireless communication system according to an embodiment.

Referring to FIG. 12, the BS may include a transceiver referred to as a BS receiver 1200 and a BS transmitter 1210, a memory (not illustrated), and a BS processor 1205 (or a BS controller or processor). According to the above described communication method of the BS, the transceiver 1200 and 1210 of the BS, memory, and BS processor 1205 may operate. However, the components of the BS are not limited to the above-described example. For example, the BS may include more or fewer components than the above described components. Furthermore, the transceiver, memory, and processor may be implemented with a single chip.

The transceiver may transmit and receive a signal to and from the UE. Herein, the signal may include control information and data. To do this, the transceiver may be constituted with an RF transmitter for up-converting and amplifying a frequency of a transmitted signal, an RF receiver for low-noise-amplifying a received signal and down-converting a frequency of the received signal, and the like. However, this is only an embodiment of the transceiver, and the components of the transceiver are not limited to the RF transmitter and RF receiver.

In addition, the transceiver may receive a signal via a radio channel, output the signal to the processor, and transmit the signal outputted from the processor via a radio channel.

The memory may store a program and data necessary for the operation of the BS. In addition, the memory may store control information or data included in the signal transmitted and received by the BS. The memory may be configured with a storage medium such as a ROM, a RAM, a hard disk, a CD-ROM, and a DVD, or a combination thereof. In addition, the memory may be in plural.

The processor may control a series of processes to operate the BS according to the above-described embodiment of the disclosure. For example, the processor may control each component of the BS to constitute and transmit two-layer DCI including allocation information of multiple PDSCHs. The processor may be in plural, and the processor may execute the program stored in the memory to thus perform control operation of the component of the base station.

The methods described herein may be implemented in software, hardware, or a combination of hardware and software.

When implemented in software, a computer-readable storage medium storing one or more programs (software modules) may be provided. The one or more programs stored in the computer-readable storage medium are configured for execution by one or more processors in an electronic device. The one or more programs may include instructions that cause the electronic device to perform the methods in accordance with the scope of the disclosure.

Such a program (software module, software) may be stored to a RAM, a non-volatile memory including a flash memory, a ROM, an electrically erasable programmable ROM (EEPROM), a magnetic disc storage device, a CD-ROM, DVDs or other optical storage device, and a magnetic cassette. Alternatively, it may be stored to a memory combining part or all of those recording media. In addition, each constituent memory may be included in plural.

The program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

Herein, each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create indicates for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction indicates that implement the function specified in the flowchart block(s). The computer program instructions may also be loaded onto a computer or other programmable data processing apparatus to cause a series of operational steps to be performed on the computer or other programmable data processing apparatus to produce a computer implemented process such that the instructions that execute on the computer or other programmable data processing apparatus provide steps for implementing the functions specified in the flowchart block(s).

Each block may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed substantially concurrently or the blocks may sometimes be executed in the reverse order, depending upon the functionality involved.

As used in the embodiments, the term unit refers to software or hardware components, such as a field programmable gate array (FPGA) or an application specific integrated circuit (ASIC), and unit performs a predetermined function. However, the unit does not always have a meaning limited to software or hardware. The unit may be constructed either to be stored in an addressable storage medium or to execute one or more processors. Therefore, the unit includes, for example, components such as software components, object-oriented software components, class components, and task components, processes, functions, properties, procedures, sub-routines, segments of a program code, drivers, firmware, micro-codes, circuits, data, database, data structures, tables, arrays, and parameters. The components and functions provided by the unit may be either combined into a smaller number of components and a unit, or divided into additional components and a unit. Moreover, the components and units may be implemented to execute one or more CPUs within a device or a security multimedia card. Further, in the embodiments, the unit may include one or more processors.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a user equipment (UE) in a communication system, the method comprising:
receiving, via higher layer signaling, a configuration of a first number of paging occasions (POs) for a paging frame (PF), the first number of POs being associated with the UE with capability of reception of a wake-up signal (WUS);
receiving a wake-up signal (WUS);
identifying, based on the configuration, the first number of POs; and
monitoring the first number of POs to receive downlink control information (DCI) for a paging message.

2. The method of claim 1, wherein indices of the first number of POs are determined by:
i_s=floor (UE_ID/N) mod Ns_WUS, where:
i_s is an index of a PO among the first number of POs,
UE_ID is an identifier corresponding to the UE,
N is a number of total PFs in a discontinuous reception (DRX) cycle of the UE, and
Ns_WUS is the first number.

3. The method of claim 1, wherein the WUS is received via a WUR of the UE, wherein a main radio (MR) of the UE is activated based on the WUS and the first number of POs are monitored via the activated MR.

4. The method of claim 1, wherein the first number of POs are configured separately from a second number of POs associated with a UE without capability of reception of the WUS.

5. The method of claim 4, wherein indices of the first number of POs are determined by:
i_s=floor(UE_ID/N) mod Ns_WUS+Ns, where:
i_s is an index of a PO among the first number of POs,
UE_ID is an identifier corresponding to the UE,
N is a number of total PFs in the DRX cycle of the UE,
Ns_WUS is the first number of POs, and
Ns is the second number.

6. A user equipment (UE) in a communication system, the UE comprising:
a transceiver; and
a processor coupled with the transceiver and configured to:
receive, via higher layer signaling, a configuration of a first number of paging occasions (POs) for a paging frame (PF), the first number of POs being associated with the UE with capability of reception of a wake-up signal (WUS);
receive a wake-up signal (WUS);
identify, based on the first configuration, the first number of POs; and
monitor the first number of POs to receive downlink control information (DCI) for a paging message.

7. The UE of claim 6, wherein indices of the first number of POs are determined by:
i_s=floor(UE_ID/N) mod Ns_WUS, where:
i_s is an index of a PO among the first number of POs,
UE_ID is an identifier corresponding to the UE,
N is a number of total PFs in a discontinuous reception (DRX) cycle of the UE, and
Ns_WUS is the first number.

8. The UE of claim 6, wherein the WUS is received via a WUR of the UE,
wherein a main radio (MR) of the UE is activated based on the WUS and the first number of POs are monitored via the activated MR.

9. The UE of claim 6, wherein the first number of POs are configured separately from a second number of POs associated with a UE without capability of reception of the WUS.

10. The UE of claim 9, wherein indices of the first number of POs are determined by:
i_s=floor(UE_ID/N) mod Ns_WUS+Ns, where:
i_s is an index of a PO among the first number of POs,
UE_ID is an identifier corresponding to the UE,
N is a number of total PFs in the DRX cycle of the UE,
Ns_WUS is the first number of POs, and
Ns is the second number.

11. A method performed by a base station in a communication system, the method comprising:
transmitting, to a user equipment (UE) via higher layer signaling, a configuration of a first number of paging occasions (POs) for a paging frame (PF), wherein the first number of POs are associated with the UE with capability of reception of a wake-up signal (WUS);
transmitting, to the UE, the WUS; and
transmitting, to the UE, downlink control information (DCI) for a paging message on at least one of the first number of POs.

12. The method of claim 11, wherein indices of the first number of POs are determined by:
i_s=floor(UE_ID/N) mod Ns_WUS, where:
i_s is an index of a PO among the first number of POs,
UE_ID is an identifier corresponding to the UE,
N is a number of total PFs in a discontinuous reception (DRX) cycle of the UE, and
Ns_WUS is the first number.

13. The method of claim 11, wherein the WUS corresponds to activate a main radio (MR) of the UE.

14. The method of claim 11, wherein the first number of POs are configured separately from a second number of POs associated with a UE without capability of reception of the WUS.

15. The method of claim 14, wherein indices of the first number of POs are determined by:
i_s=floor(UE_ID/N) mod Ns_WUS+Ns, where:
i_s is an index of a PO among the first number of POs,
UE_ID is an identifier corresponding to the UE,
N is a number of total PFs in the DRX cycle of the UE,
Ns_WUS is the first number of POs, and
Ns is the second number.

16. A base station in a communication system, the base station comprising:
a transceiver; and
a processor coupled with the transceiver and configured to:
transmit, to a user equipment (UE) via higher layer signaling, a configuration of a first number of paging occasions (POs) for a paging frame (PF), wherein the first number of POs are associated with the UE with capability of reception of a wake-up signal (WUS);
transmit, to the UE, the WUS; and
transmit, to the UE, downlink control information (DCI) for a paging message on at least one of the first number of POs.

17. The base station of claim 16, wherein indices of the first number of POs are determined by:
i_s=floor(UE_ID/N) mod Ns_WUS, where:
i_s is an index of a PO among the first number of POs,
UE_ID is an identifier corresponding to the UE,
N is a number of total PFs in a discontinuous reception (DRX) cycle of the UE, and
Ns_WUS is the first number.

18. The base station of claim 16, wherein the WUS corresponds to activate a main radio (MR) of the UE.

19. The base station of claim 16, wherein the first number of POs are configured separately from a second number of POs associated with a UE without capability of reception of the WUS.

20. The base station of claim 19, wherein indices of the first number of POs are determined by:
i_s=floor(UE_ID/N) mod Ns_WUS+Ns, where:
i_s is an index of a PO among the first number of POs,
UE_ID is an identifier corresponding to the UE,
N is a number of total PFs in the DRX cycle of the UE,
Ns_WUS is the first number of POs, and
Ns is the second number of POs.
